(19) United States
(12) Patent Application Publication
(10) Pub. No.: US 2026/0322833 A1
(43) Pub. Date: Oct. 15, 2026

(54) CYBERSECURITY THREAT DETECTION AND MITIGATION

(71) Applicant: Skidaway, Inc., San Francisco, CA (US)

(72) Inventors: Josiah Lashley, Sunnyvale, CA (US); Kumar Mayank, Santa Clara, CA (US); Evan Powell, San Mateo, CA (US); Praise Oluwatosin Olukilede, Oakland, CA (US)

(21) Appl. No.: 19/648,962

(22) Filed: Apr. 15, 2026

Related U.S. Application Data
(60) Provisional application No. 63/789,119, filed on Apr. 15, 2025.

(51) Int. Cl. H04L 9/40; H04L 41/16

(52) U.S. Cl. CPC H04L 63/1416; H04L 41/16

(57) ABSTRACT

Cyber-threats related to an IT system may be detected by: acquiring an event sequence comprising a plurality of network related events from the IT system occurring over some time period; obtaining, corresponding to the event sequence, a corresponding tokenized event sequence comprising a plurality of corresponding tokenized events by tokenizing the plurality of network related events; embedding each corresponding tokenized event with a corresponding positional embedding and a corresponding event embedding to obtain a corresponding positionally-embedded and event-embedded tokenized event sequence; detecting, by a pre-trained log foundation model trained on network related logs, based on the corresponding positionally-embedded and event-embedded tokenized event sequence, one or more anomalies associated with the one or more network related events, wherein the anomalies are detected based on output embeddings in the pre-trained log foundation model; and outputting anomaly information indicative of the one or more anomalies

### CROSS REFERENCE TO RELATED APPLICATIONS

This application claims the benefit of and priority to U.S. Provisional Patent Application No. 63/789,119 entitled “TRANSFORMER-BASED FOUNDATION MODELS FOR CYBERSECURITY DEFENSE ANOMALY DETECTION AND ISOLATION,” filed Apr. 15, 2025, and assigned to the assignee hereof. The above-identified application is hereby incorporated by reference in its entirety for all purposes.

### TECHNICAL FIELD

This application pertains to the area of cyber security and, more specifically, to systems to detect and mitigate cyber threats.

### BACKGROUND

Enterprises and governments face increasingly sophisticated cyber threats that conventional detection systems struggle to detect and effectively mitigate. As information technology (IT) systems evolve and grow in terms of complexity, scale, connectivity, external and internal interfaces, diversity of device types, and deployed resources, detecting and mitigating cyber threats that arise can become increasingly challenging. For example, in many instances, if cyber threats are not quickly detected, neutralized, and/or effectively countered, they can render entire systems dysfunctional and prevent access to or delivery of mission critical organizational services. In other situations, malware and/or bad actor behavior may lead to exfiltration of sensitive information damaging organizational reputation, compromising competitiveness, rendering organizations liable for resulting damages, and/or to a loss of customers.

The nature of these threats, which are constantly evolving, also make them challenging to detect reliably. While backups, redundancy, etc. may help with recovery when IT systems are attacked, they are not effective to prevent such attacks a priori or in a timely manner. Existing approaches to threat mitigation are also typically effective after the threats are well-known and documented. The ability of conventional approaches to deal with emergent threats is often non-existent or limited. In addition, even where such capability exists, false alarms (identifying benign actions as threats) and false negatives (e.g. a failure to detect a real threat or incorrectly deeming an identified threat as benign) can lead to situations where trust in the cyber threat detection system's functionality is detrimentally affected, which can lead to genuine threats being ignored.

### SUMMARY

A processor-implemented method to detect cyber-threats related to an information technology (IT) system, the method comprising: acquiring an event sequence comprising a plurality of network related events from the IT system, wherein the plurality of network related events occur over a time period; obtaining, corresponding to the event sequence, a corresponding tokenized event sequence comprising a plurality of corresponding tokenized events, the plurality of corresponding tokenized events obtained by tokenizing the plurality of network related events; embedding each corresponding tokenized event in the plurality of corresponding tokenized events with a corresponding positional embedding and a corresponding event embedding to obtain a corresponding positionally-embedded and event-embedded tokenized event sequence; detecting, by a pre-trained log foundation model trained on network related logs, based on the corresponding positionally-embedded and event-embedded tokenized event sequence, one or more anomalies associated with the one or more network related events, wherein the anomalies are detected based on output embeddings in the pre-trained log foundation model; and outputting anomaly information indicative of the one or more anomalies.

A system to detect cyber-threats related to an information technology (IT) system, the system comprising: at least one computer comprising a processor, a memory, and a network interface wherein the processor is configured to: acquire, over the network interface, an event sequence comprising a plurality of network related events from the IT system, wherein the plurality of network related events occur over a time period; obtain, corresponding to the event sequence, a corresponding tokenized event sequence comprising a plurality of corresponding tokenized events, the plurality of corresponding tokenized events obtained by tokenizing the plurality of network related events; embed each corresponding tokenized event in the plurality of corresponding tokenized events with a corresponding positional embedding and a corresponding event embedding to obtain a corresponding positionally-embedded and event-embedded tokenized event sequence; detect, by a pre-trained log foundation model trained on network related logs, based on the corresponding positionally-embedded and event-embedded tokenized event sequence, one or more anomalies associated with the one or more network related events, wherein the anomalies are detected based on output embeddings in the pre-trained log foundation model, the output embedding being stored in the memory; and initiate output, to an entity in the IT system over the network interface, of anomaly information indicative of the one or more anomalies.

A non-transitory computer readable medium comprising instructions to configure a processor to perform a method of detecting cyber-threats related to an information technology (IT) system, the method comprising: acquiring an event sequence comprising a plurality of network related events from the IT system, wherein the plurality of network related events occur over a time period; obtaining, corresponding to the event sequence, a corresponding tokenized event sequence comprising a plurality of corresponding tokenized events, the plurality of corresponding tokenized events obtained by tokenizing the plurality of network related events; embedding each corresponding tokenized event in the plurality of corresponding tokenized events with a corresponding positional embedding and a corresponding event embedding to obtain a corresponding positionally-embedded and event-embedded tokenized event sequence; detecting, by a pre-trained log foundation model trained on network related logs, based on the corresponding positionally-embedded and event-embedded tokenized event sequence, one or more anomalies associated with the one or more network related events, wherein the anomalies are detected based on output embeddings in the pre-trained log foundation model; and outputting anomaly information indicative of the one or more anomalies.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the present disclosure. Accordingly, the drawings and description are to be regarded as illustrative in nature and not as restrictive.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings of which:

FIG. 1 depicts an example IT system 100 on which a cyber threat detection and mitigation system may be deployed in a manner consistent with embodiments described herein.

FIG. 2A shows an example log foundation model and log foundation model training flow 200 associated with a foundation model for cyber threat detection and mitigation in accordance with embodiments disclosed herein.

FIG. 2B shows a flowchart of an example preprocessing method 250 to preprocess raw log data 252.

FIG. 2C shows a flowchart of a tokenization method 270 associated with example tokenizer 275 for tokenization of an event stream.

FIG. 3A shows fields in an example NetFlow log 300.

FIG. 3B shows fields in an example Virtual Private Cloud (VPC) Flow log item 375.

FIG. 3C shows an example entity-pair event record 390 obtained after preprocessing.

FIG. 4 shows an example and classifier architecture and classifier training flow 400 for classifiers associated with log foundation model 200.

FIG. 5A shows a deployed system 500 comprising a pre-trained (frozen) log foundational model and trained classifiers 410.

FIG. 5B shows an example flow for a framework for active learning 550 in conjunction with a deployed system for anomaly detection.

FIG. 6 shows a flowchart of an example cyber threat detection method 600 consistent with embodiments disclosed herein.

FIG. 7 shows a block diagram is shown depicting an exemplary computer 600.

### DETAILED DESCRIPTION

While various embodiments of the present disclosure have been shown and described herein, such embodiments are provided by way of example only. Numerous variations, changes, or substitutions may occur without departing from the present disclosure. It should be understood that various alternatives to the embodiments of the present disclosure described herein may be employed.

With the growth of IT systems (also referred to as “systems”), cyber threats have also grown significantly. IT systems today are more complex in that they involve more diverse types of infrastructure such as networked data centers, servers, computers, handhelds, mobile devices, as well as private, public and hybrid private-public clouds. The public clouds may be hosted by multiple vendors and provide infrastructure (IaaS), platforms (PaaS), software (SaaS) and other services. Complexity may also increase because IT systems may be geographically distributed, remote, and use various modalities such—such as wireless (e.g. Wireless Wide Area Networks (WWANs), Wireless Local Area Networks (WLANs), and/or Wireless Personal Area Networks (WPANs)) and/or wired networks to access IT systems and resources.

The term WWAN refers to cellular or mobile telecommunications networks such as 5G/5G-Advanced, 4G/Long Term Evolution (LTE), 3G/Universal Mobile Telecommunications System (UMTS), and other standards from the 3rd Generation Partnership Project (3GPP) and related standards organization. WLAN refer to networks based on the IEEE 802.11x based standards from the Institute of Electrical and Electronics Engineers (IEEE) LAN/MAN Standards Committee. WPAN refers to standards based on IEE 802.15x standards such as Bluetooth, etc. Wired networks may include those based on high-speed protocols, fiber based, InfiniBand, and IEEE 802.3 based standards such as Ethernet including Gigabit Ethernet (GbE), etc.

The number of devices and types of devices (e.g. servers, workstations, personal computers, mobile devices such as tablets, handhelds, and mobile devices—hereinafter collectively referred to as “computing devices” or “platforms”) that are connected to IT systems has also been growing significantly. Interfaces, both software (e.g. services, Application Programming Interfaces (APIs), AI model prompts) and hardware (e.g. routers, gateways, computing devices, etc.) can also serve as points from where threats can emanate. Thus, cyber security solutions that: (a) are scalable with IT system growth, (b) work across a diversity of computing devices/platforms, (c) can adapt and evolve with IT system changes, and (d) address emergent cyber threats are desirable.

Conventional cyber threat detection systems often use a set of rules (e.g. number of login failures over some time period, other logic based approaches using parameters such as IP addresses, data volumes being transferred, etc.), and/or signature-based techniques (e.g. hashes, specific strings, registry or file system signatures, etc.) to detect and flag cyber threats and may then rely on subsequent human judgment for mitigation.

Conventional Machine Learning (“ML”) based cyber threat detection systems have been largely XGBoost based. XGBoost based models start with weak-learners, which are then combined using gradient boosting to sequentially build stronger predictive decision trees that correct previous errors. The gradient in XGBoost is based on a loss function and is a measure of the discrepancy between a model's prediction from actual values. XGBoost uses regularization, which adds penalties to the objective function to discourage complex tree structures and overfitting.

In modern environments, where cyber threats update tactics, techniques, and proliferate rapidly, the techniques outlined above often are unable to adapt with adequate speed. Updates to rule and signature based techniques to detect new threats can take time and involve multiple iterations. Conventional ML based approaches can be brittle because IT system environment changes can affect performance. For example, adapting to changes in the IT system/environment or learning to identify new attacks may take several months. Moreover, in conventional ML models, predictive abilities can be constrained by training data so that drift and breakdowns are not uncommon when entirely new threats are encountered. Drift refers to a degradation of a model's predictive capabilities, which can occur because of environmental changes such as system and/or threat changes.

In addition, deploying, maintaining, and updating conventional cyber threat detection ML models may depend on substantial manual data analysis, which can be time consuming and labor intensive. Moreover, when deployed, these models can sometimes output large numbers of false positives, which can decrease efficiencies by wasting resources and increasing costs. For example, some conventional cyber security system may flood cyber security professionals with alerts leading to “alert fatigue.” Alert fatigue can become a real challenge in cybersecurity systems frustrating cyber security professionals causing sub-optimal resource deployment, which can lead to real threats being ignored.

Disclosed embodiments leverage log-based foundation models that use self-supervised learning based on logs generated in IT systems to learn patterns that are used during model deployment to detect, identify, and/or mitigate cyber threats. A foundation model is an Artificial Intelligence (AI) model that is trained on a large corpus of unlabeled data using self-supervision. The term self-supervised learning or self-supervision refers to ML techniques where models generate supervision signals from the corpus of unlabeled data. For example, self-supervision can involve the prediction of missing and/or masked (deliberately hidden) portions of the input data to learn significant features. The supervisory signals in self-supervised learning are often based on loss functions, which indicate a deviation from the target (e.g. missing or masked) output. Loss function based approaches may be used to obtain supervisory signals that guide the model to learn to more accurately derive correct results from input data. Self-supervision facilitates the training of models on massive and unstructured datasets.

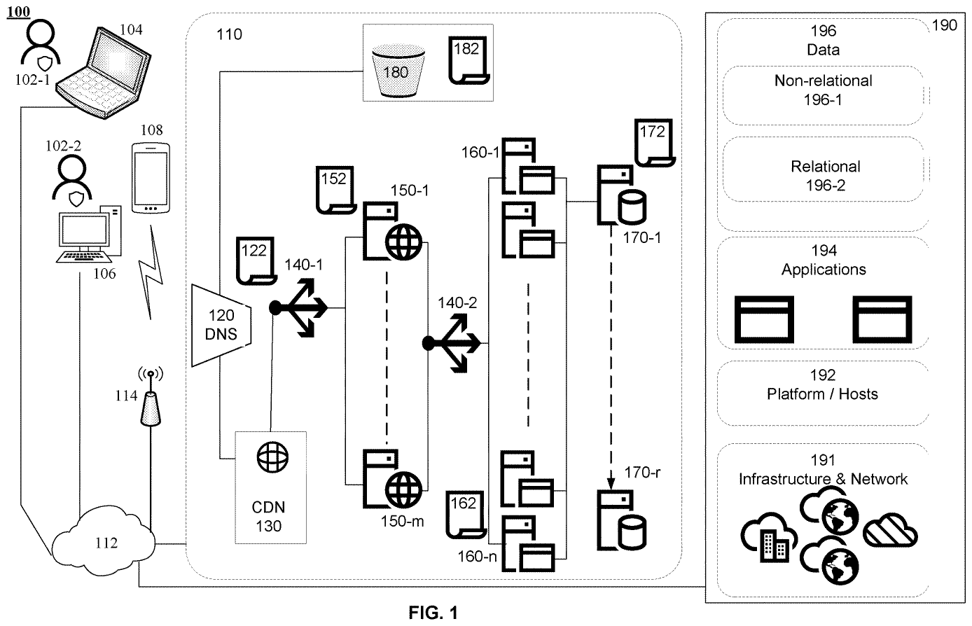

FIG. 1 depicts an example IT system 100 (hereinafter referred to as “system 100”) on which a cyber threat detection and mitigation system may be deployed in a manner consistent with embodiments described herein. FIG. 1 illustrates various example entities and some example interactions between depicted entities. The term “entity” is used to refer to users, devices (computers, tablets, servers, workstations, access points, routers, network attached devices, etc.), and/or other actors (e.g. services, virtual machines, etc.) that may access, attempt to access, and/or use system 100 or resources provided by system 100. Access or access attempts may from within system 100 or may occur externally such as via the Internet.

For example, as shown in FIG. 1, users 102-1, 102-2, etc. may use various devices such as notebook computer 104 and workstation 106 to connect to network 112. In some instances, user 102 may connect wirelessly to network 112 using mobile device 108 and wireless access point (WAP) 114. In general, entities may communicate with other entities over network 112 and may access or request access to access resources in subsystem 110. Communication between a first entity and another entity over network 112 and/or with network 112 and/or elements of network 112 may use protocols such as Transport Control Protocol/Internet Protocol (TCP/IP) or variants thereof.

TCP/IP is a 5 layer networking framework widely used for communication over networks (including the Internet, where the protocol defines how data is packaged, addressed, transmitted, routed, and received across networks. Each layer in the TCP/IP performs specified functions. These layers (not shown in FIG. 1) are described briefly below. The layers are collectively referred to as the TCP/IP stack.
(1) The Physical Layer (level or layer 1), which (a) transmits raw bits over physical media (e.g. cables, signals, connectors, etc.), (b) may convert digital data to signals (e.g. electrical, optical, radio, etc.) compatible with the physical media, and (c) specify the data transmission rate and physical topologies (e.g. bus, mesh, ring, etc). Network hubs, repeaters, and Network Interface Controllers (NICs) may often implement the TCP/IP physical layer. Typically, these (and other network attached) devices have unique Medium Access Control (MAC) addresses, which can be used for device identification.
(2) The Data Link Layer (level or layer 2) provides (a) node-to-node communication, (b) implements the data link protocol (e.g. Ethernet or WiFi), (c) provides framing, which encapsulates physical layer packets into units called frames (e.g. by adding a header and a trailer), (d) uses MAC addresses for device identification, (e) performs flow control (e.g. to match differing device transmit/receive speeds) and (f) performs error detection. Network switches, Access Points (APs) such as WAP 114, bridges, and modems may implement the data link layer.
(3) The Network Layer (level or layer 3) may provide (a) logical addressing (e.g. IP addressing using, for example, IPv4/IPv6) by (b) implementing appropriate protocols such as Internet Protocol (IP) (e.g. for addressing and routing), Internet Control Message Protocol (ICMP—for error/diagnostic messages, Address Resolution Protocol (ARP—e.g. to translate logical address to physical addresses), Reverse ARP (RARP—to obtain logical addresses from physical addresses), etc., (c) provide packet routing to determine a path to the packet destination and (d) packet fragmentation (e.g. to ensure packet sizes can be handled by the network). Routers, Layer 3 switches, and firewalls are examples of devices that may implement this layer.
(4) The Transport Layer (level or layer 4) provides (a) end-to-end (e.g. from an application on one device to another application on a different device) communication, and (b) reliability (e.g. error detection, retransmission of lost packets, etc) and (c) may use (i) TCP (a Layer 4 protocol for reliable, ordered, and error-checked data delivery between end points, guaranteeing that all packets arrive correctly). TCP is leveraged for web browsing, file transfers, remote access, email, etc. The Transport Layer may also use (ii) the User Datagram Protocol (UDP) for fast, connectionless (no handshake), low-overhead delivery, which is useful for Voice over Internet Protocol (VoIP) calls, streaming, conferencing, broadcasting, multicasting, Domain Name Server (DNS) lookups e.g. via DNS 120, etc. The transport layer is typically handled as part of a computer operating system software stack although, in some instances, specialized devices may implement portions or devices such as load balancers e.g. load balancers 140, may inspect layer 4 headers.
The (5) Application Layer (level or layer 5) (a) provides network services to end-user applications, (b) implements high level protocols like the HyperText Transfer Protocol (HTTP), File Transfer Protocol (FTP), Simple Mail Transfer Protocol (SMTP), DNS, Dynamic Host Configuration Protocol (DHCP), Simple Network Management Protocol (SNMP), etc. (c) formats data, handles resource sharing, remote file access, email, web browsing and communication services, session states, etc. The application layer is typically handled as part of a computer operating system software stack, and/or network drivers, and/or user applications.

TCI/IP stack logs provide a detailed, layered view of network data transmission. Each layer may provide logs, which can be used for diagnostics, troubleshooting connectivity issues, for security, and to detect protocol errors. TCP/IP stack logs may capture packet-level details, including timestamps (which typically include date, time and time zone information), MAC addresses (data link layer), IP addresses (network layer), and payload data (transport/application layers). For example, physical layer logs may indicate the status of hardware media, such as cables, connectors, and signal transmission. such as whether a link is working (e.g. interface Ethernet0/0 link up, line protocol is up, etc). As another example, a data link layer log (e.g. ARP log) may indicate a mapping between an IP address and a MAC address, and may also provide information on framing and local network connectivity. Network layer logs may provide information on protocol used, logical addressing (IP) and routing. For example, in the case of a firewall, a log may indicate the protocol and allowed IP packets from some source address to a destination address. At the transport layer level, logs may provide information on end-to-end connections (e.g. a local computer and remote server), including port numbers used, and connection state (TCP or UDP). Known or standard port numbers used by certain protocols may be used to determine protocol. For example, port 443 is used by HTTPS. At the application layer level logs may be generated by applications (browsers, email, servers), which can provide information on user interactions/sessions, status, and higher-level protocols like HTTP/DNS. For example, web server such as Apache or nginx logs may indicate that an HTTP “GET” request was issued from a client IP address for a specific file at a specified time (e.g. using a timestamp), and indicate that the request was successfully completed. Logs may also provide payload information. In addition to TCP/IP stack logs, other devices, services, and/or applications may provide their own logs. For example, network security tools such as Intrusion Detection System (IDS) and Intrusion Prevention System (IPS) may monitor network traffic for malicious activity and provide logs with information relating to the activity seen, logged, and any actions taken. These logs could include information on suspicious activity at specific layers, such as unusual traffic volumes (TCP/IP transport layer—level 4) or malformed packets (TCP/IP network layer—level 3).

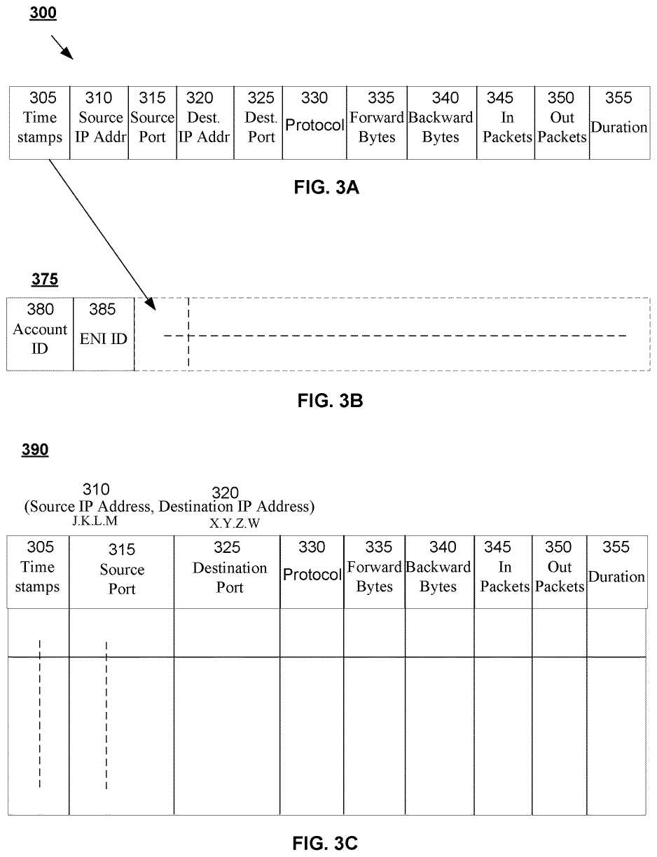

FIG. 3A shows fields in an example NetFlow log 300. As shown in FIG. 3A, a NetFlow log item for an instance where two entities communicate may include fields such as Timestamps (e.g. date, time, time zone information) 305, Source IP Address 310, Source Port 315, Destination IP Address 320, Destination Port 325, Protocol 330 used for communication, the number of Forward Bytes 335, the number of Backward Bytes 340, the number of Incoming Packets 345, the number of Outgoing Packets 350, and the Duration 355 for the communication. FIG. 3A is merely an example NetFlow log used for illustrative purposes. In general, various other network log files (e.g. such as one or more of those outlined above in relation to FIG. 1, the TCP/IP stack, etc) may be used both to pre-train log foundation model 200 and as input to pre-trained log foundation model 200. In addition, the fields shown in FIG. 3A are also examples. Other fields such as “connection state,” (e.g. LISTEN, SYN_SENT, ESTABLISHED, TIME_WAIT, etc.), which may indicate the specific stage of a communication session that specifies a current condition of the link between two entities (e.g. a client and a server) may also form part of the log item.

In some embodiments, NetFlow data may be supplemented by enriched network metadata, which may be available using network monitoring tools (e.g. Zeek), which can provide additional context such as application-layer details and connection states. In addition, DNS logs, DHCP records, and firewall metadata can also provide complementary network-level insights.

In addition, other network protocols such as those used for high performance computing (HPC) may also be used in system 100. HPC protocols may be based on networking and communication standards that facilitate ultra-low latency (e.g. packet travel delay between network nodes), high bandwidth (e.g. maximum data transfer capacity), and massive scalability (ability to maintain performance with system growth—e.g. as entities proliferate). These protocols may include InfiniBand, IP over InfiniBand (IPoIB), Remote Direct Memory Access (RDMA), RDMA over Converged Ethernet (RoCE), and Message Passing Interface (MPI), which enable efficient, parallel processing for simulations, AI, and big data. In some embodiments, libraries such as the NVIDIA Collective Communications Library (NCCL) or the Compute Unified Device Architecture (CUDA) may provide functions that facilitate use of features or capabilities provided by the above protocols.

Referring to FIG. 1, example subsystem 110 may form part of system 100. Subsystem 100 may comprise DNS resolution server 120 (e.g., which may be coupled to a Content Delivery Network (CDN) 130. CDN 130 may access resources and content from data server 180. In some embodiments, DNS log 122 and data server log 182 may be generated by DNS 120 and server 180. DNS log 122 may provide information related to the DNS request and interaction (e.g. timestamps, requesting device IP address, domain name(s) for which resolution was requested, etc), while server log 182 may provide information about server access requests including timestamps, IP address of requesting devices, user names, data requested, request status, etc.

CDN 130 may be coupled to elastic load balancer 140-1, which may dynamically instantiate and distribute workload across auto-scaling web servers 150-1 through 150-m (collectively referred to as “web servers 150”). Load balancers 140 may generate logs 142 related to requests received, services requested, IP addresses, latencies, traffic, and servers handling the request, etc. Likewise, web servers 150 may be generate web server logs, which may use a Common Log Format (CLF) or Combined Log Format and provide information on IP Addresses (e.g. 192.0.10.1) of client requests. user id (e.g. of user 102) of a user making the request(s) when available, timestamps, request line(s) (e.g. “GET /index.html HTTP/1.1”): which may include the HTTP method (GET), the requested resource path (/index.html), and the protocol version (HTTP/1.1), and the status including the server's response such as success (200), “not found” (404), server error (500), response size indicating the amount of data in bytes sent back to the client.

Web servers 150 may be coupled to elastic load balancer 140-2, which may dynamically instantiate and distribute workload across auto-scaling application servers 160-1 through 160-n (collectively referred to as “application servers 160”). Application servers 160 may generate application server logs 162. Application server logs may include information such as user names, timestamps, IP addresses of requestor(s), resources accessed, network data transfer related information, change logs related to changes made (users added/deleted, blacklists, whitelists, configuration changes, version changes, etc.), security related incidents, etc. and other events (e.g. backups), event status (e.g. backup successful, etc.), and event severity, application availability, uptime, downtime, etc.

Application servers 160 may be coupled to database servers 170-1 through 170-r (collectively referred to as “database servers 170”). Database servers may generate database server logs 172 with timestamps related to users, user requests, and transaction logs, which may include data accessed, queries, data modifications, status etc.

In addition, entities associated with system 100 may also access cloud-based systems 190, which may be some combination of public clouds, private clouds or hybrid public-private clouds. Example cloud based system 190 may comprise several subsystems such as infrastructure and network subsystem 191, which may be cloud based (e.g. Amazon Web Services (AWS), Microsoft Azure, VMware, and/or hybrid clouds). Platforms/hosts 192 (e.g. Red Hat Openshift, Docker, AWS Lambda, etc.) may use infrastructure and network subsystem 191 to deliver platform based services. Further, cloud-based applications 194 may provide software related services leveraging functionality provided by platform/hosts 192 and/or infrastructure and network subsystem 191. Cloud-based system 190 may further include data subsystem 196, which may comprise relational databases 196-2 (e.g. MySQL, Postgres SQL, etc.), non-relational databases 196-1 (Apache HBase, Apache Hive, etc.), and storage (e.g. Amazon S3, etc.). Each of the above subsystems may generate logs related to user and/or entity activities on cloud based system 190.

Logically, each subsystem or portion thereof, such as cloud computing subsystem 210 (e.g. Amazon EC2), cloud storage subsystem 230 (e.g. Amazon S3), database subsystem 240, network subsystem 220, may be governed by a respective set of access control policies. Further, users 102-1, 102-2, 102-3 . . . 102-s (collectively referred to as users 102) may also be associated with respective groups each with associated access permissions, and services 202-1, 202-2, 202-3 etc. (collectively referred to as services 202) may also be associated with respective access permissions. The terms “access permissions” and “access privileges” are used interchangeably herein and relate to the conditions under which an entity (actor) may access an object (resource or another entity) and the type of access available to the actor.

FIG. 3B shows fields in an example Virtual Private Cloud (VPC) Flow log item 375. In some embodiments, VPC log 375 may include fields for Account ID 380 to indicate the user account, and Elastic Network Interface (ENI) ENI ID 385. ENI ID 385 identifies a virtual network card in a VPC that can be attached to, or detached from, cloud instances. VPC Flow Logs log monitored network features in cloud system 190 (e.g. AWS, Google Cloud, or Azure) and capture metadata associated with IP traffic moving to and from Elastic Network Interfaces (ENIs) within the VPC. In addition to the Account ID 380 and ENI ID 385, VPC Flow logs may provide a structured log with similar details as NetFlow log item 300 (as shown by the arrow from FIG. 3A to FIG. 3B) that includes metadata about network flows. VPC Flow logs which operate at layers 3 and/or 4 of the TCP/IP stack are often generated by a cloud platform's virtual infrastructure.

In general, as a system (such as system 100) grows in complexity, with thousands of entities that interact and communicate, manual intervention for cyber security management, or conventional ML rule-based or signature based approaches to detect and mitigate threats can become impracticable. Accordingly, some disclosed embodiments facilitate greater automation, adaptability, scalability, and relatively short deployment timelines.

Accordingly, disclosed embodiments leverage log-based foundation models that use self-supervised learning based on logs generated in IT systems to learn patterns that are used, during model deployment, to detect, identify, and/or mitigate cyber threats. In some embodiments, the foundation model trains over sequences of logged items over a timeline to identify and determine logged events. A “logged event,” as used herein, may refer to a sequence of logged events over a timeline that is determined (e.g. by a trained foundation model) to correspond to a real-world event. In some embodiments, the foundation model infers, from log data, a timeline of events that may be determined to correspond to normal, regular, or typical (hereinafter “typical”) operation of system 100. For example, a timeline of logged events between two entities may be determined to correspond to a typical interaction between the two entities. As another example, a workstation (entity A) may routinely communicate with an internal file server (entityB) during business hours with predictable port usage, byte volumes, and session durations. If entity A subsequently initiates connections to entity B at unusual hours, using atypical ports, or with anomalous byte transfer volumes, the foundation model may flag this behavior as potentially anomalous. In some embodiments, deviation from patterns of typical interaction between entities in system 100 may be flagged and used to determine the presence or absence of cyber threats.

In some embodiments, the foundation model may be trained on logs based on interactions between one or more pairs of IP address (IP-IP), and/or one or more pairs of users (User-User), and/or one or more pairs of entities (Entity-Entity). The logs used to train the foundation model may be at various levels of the TCP/IP stack and may include structured logs such as those obtained via NetFlow. NetFlow is a network monitoring protocol to log IP traffic flows and provides structured, machine-readable logs (e.g. in JSON or key-value pairs) that captures source and destination IP addresses, source and destination ports used, protocol used (e.g. TCP, UDP, ICMP), input interface, output interface, packets and bytes transferred, and timestamps. Structured NetFlow logs provide high-volume network metadata that is useful to characterize traffic. In some embodiments, these logs may be exported from network devices (access points, routers, firewalls, switches, etc.) and used to train foundation models. Log files may also include and/or be derived from raw Packet Capture (PCAP) data. PCAP log files are reflective of actual network traffic and encompass a vast array of detailed behavioral data that Intrusion Detection Systems (IDS) utilize to label network activities. In some embodiments, log foundation model training may be based on n benign segments of the PCAP data.

In some embodiments, foundation model training may also occur on unstructured logs such as Web Application Firewall (WAF) logs and DNS logs, WAF logs are records generated by a web application firewall that inspects bidirectional (both inbound and outbound) web traffic (e.g. over HTTP or HTPPS) to protect applications from threats like SQL injection, cross-site scripting (XSS), and Distributed Denial of Service (DDoS) attacks. SQL injection attacks use malicious SQL code in input fields (like forms or URLs) to make web applications execute unwanted or unauthorized database queries. DDoS attacks disrupt traffic of a target (e.g. servers, services, or networks) by attempting to overwhelm the target with a flood of Internet traffic from multiple compromised sources. XSS refers to the exploiting of vulnerabilities in situations where web applications take user input and include the input in page content without proper validation or encoding. By injecting malicious client-side scripts into trusted websites, which client-side browsers execute, attackers can steal session cookies, hijack user accounts, or deface websites. WAF logs focus on application-layer threats (HTTP/HTTPS) and web content.

DNS logs record all Domain Name System queries made by clients and captures details such as requested domain names, request headers, client IP addresses, and response types. the data in DNS logs includes timestamps, client IP addresses, requested domain names, query types, and response codes, actions taken. DNS logs focus on network-level activity, specifically domain resolution requests and can useful to determine the origins of cyber threats or cyber-attacks.

Because cyber systems can generate enormous amounts of logs that can span petabytes of data at large enterprises, computationally efficient approaches to process logs are worthwhile. Accordingly, in some embodiments, logs (e.g. NetFlow logs) may be pre-processed to extract specific log items deemed useful. In some embodiments, pre-processing may include removing log items with missing or corrupted fields, discarding fields that do not carry discriminative signal for threat detection, normalizing numerical fields such as byte counts and duration across heterogeneous log sources, compensating for vendor-specific sampling behaviors, classifying flows by timeout type (natural termination vs device imposed truncation), applying methods to group ports to decrease the number of tokens in the vocabulary, dealing with categorical and continuous variables separately while maintaining relative magnitudes.

In some embodiments, the foundation model described herein may be based on a transformer and self-attention architecture similar to that of large language models to learn patterns within logs and event streams. In some embodiments, the foundation model may be bidirectional and learn complex patterns associated with typical entity behavior based on log data and event data. The term “bi-directional” refers to the capability to incorporate context from tokens occurring prior to the current token and tokens that occur subsequent to the current token.

In some embodiments, in the context of log files herein, the term prior is both temporal (e.g. an event with an earlier timestamp) and lexical (e.g. an event textually preceding the current token in the log file). Likewise, the term subsequent is also both temporal (e.g. an event with a later timestamp) and lexical (e.g. textually succeeding the current token in the log file). In some instances, events may be obtained from redacted log data (e.g. automatically pre-processed to remove non-useful and/or redundant log items). Pre-processing of log data may use empirical data from experiments and observations. For example, empirical analysis across production deployments may reveal that certain log fields contribute negligible discriminative signal while increasing the vocabulary size, and that flow timeout behaviors vary across device vendors. In some embodiments, such observations may be used inform pre-processing rules to prevent the model from learning artifacts of the logging infrastructure rather than genuine network behavior.

In some embodiments, the trained foundational model may be deployed on a system 100 to detect anomalies, perform entity resolution, perform MITRE ATT&CK® mapping, threat intelligence mapping, and threat response, and forensics in real-time, near real-time or post-facto. Forensics refers to the post-facto determination and/or reconstruction of how cyber threats and/or an adverse action unfolded.

The term “entity resolution” refers to linking and consolidating seemingly unrelated data points (e.g. in logs) to identify if they belong to a specific real-world entity (such as a threat actor). In some embodiments, the foundation model may learn from as IP addresses, user accounts, devices, email addresses, and other data in logs to perform entity resolution. Entity resolution may facilitate the detection of malicious patterns, help map attacker infrastructure, and may reduce false positives in threat investigations.

MITRE ATT&CK® mapping refers to the process of aligning cyber threat intelligence, security alerts, or defensive controls with the MITRE ATT&CK® framework. The framework is a knowledge base of malicious actor tactics and techniques and facilitates visualization of security holes, helps prioritize defensive approaches, and understand threat actor behavior by mapping attacker techniques (“how”) to likely intent (“why”). The framework has been developed based on real-world observations.

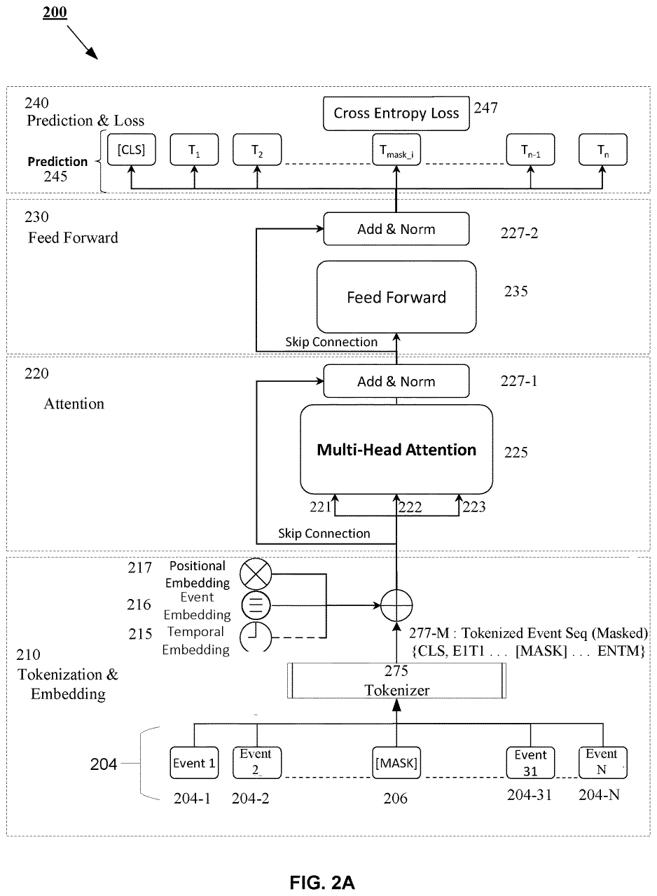

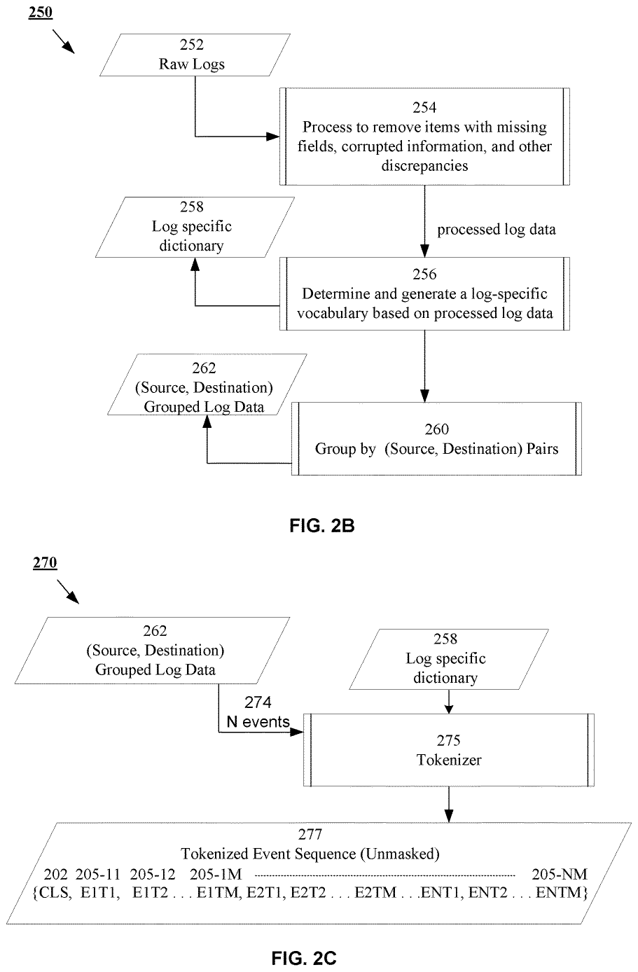

FIG. 2A shows an example log foundation model and log foundation model training flow 200 associated with a foundation model for cyber threat detection and mitigation in accordance with embodiments disclosed herein. When referring to the processes associated with training, the term “log foundation model training flow 200” is used. In FIG. 2A, the entirety of blocks shown may also form part of a log foundation model. When referring to log foundation model in its entirety, the terms “log foundation model 200,” “model 200.” “log model 200” or “foundation model 200” are used. As shown in FIG. 2A, in some embodiments, the log foundation model 200 may be multi-layered and may comprise blocks Tokenization & Embedding block 210, Attention block 220, Feed Forward block 230, and Prediction & Loss block 240, which are described below.

In some embodiments, the log foundation model 200 may use techniques based on Bidirectional Encoder Representations from Transformers (BERT). As outlined above, BERT typically pre-trains deep bidirectional representations from unlabeled text in input streams by jointly conditioning on both left and right context in all layers.

The term “pre-training” refers to initial model training, which can be based on large unlabeled datasets (e.g. logs) to learn general patterns (e.g. event sequences), representations (e.g. in multi-dimensional space) and knowledge. This creates foundation model 200 that understands syntax and context (e.g. for the log files), which can then be efficiently fine-tuned for specific tasks, saving time and computational costs

As shown in FIG. 2A, in some embodiments, input sequence 210 may comprise a sequence of events 204 (e.g. Event-1 204-1, Event 2 204-2, . . . Event 31 204-31, Event N 204-N). Some events 206 may be masked or deliberately hidden during training. As one example, each row in NetFlow may comprise an event. In some embodiments, all features/fields associated with an event may be masked when that event is masked. The term fields is used to refer to logical portions of a record (such as a NetFlow record). In some embodiments, prior to training, raw log data may be preprocessed, as described below, to obtain data based on IP pairs in the raw log data.

FIG. 2B shows a flowchart of an example preprocessing method 250 to preprocess raw log data 252. In block 254, log items in input raw log data 252 may be processed to remove items with missing fields, corrupted information, and/or other discrepancies. Raw log data 252 may be data from a variety of logs such as NetFlow, VPC, DNS, TCP/IP stack related logs, etc.) In some embodiments, during preprocessing, fields in the raw log files that are not relevant to cyber threats or attacks may be deleted without impacting the ability to detect possible threats or attacks.

In block 256, processed log data (e.g. processed in block 254) may be parsed to determine log specific vocabulary. The log specific vocabulary may be specific to the type of log being processed (e.g. NetFlow, VPC, DNS, TCP/IP stack logs, etc). In some embodiments, the log specific vocabulary may be stored or represented by log specific dictionary 258. The term “specific” in log specific dictionary refers to a vocabulary (e.g. “words”) that may be prevalent in log files generally. For example, the parsing of raw log data (in block 256) may be used to identify fields that contain continuous variable (e.g. timestamps) and categorical variables (e.g. Protocol). In some embodiments, in block 256, numerical data in log files may be normalized and binned before being integrated with categorical data. In some embodiments, log specific vocabulary (e.g. in log specific dictionary 258) may be a custom vocabulary that captures event sequences.

In block 260, the processed log data may be grouped by (Source, Destination) pairs (e.g. based on IP addresses) and output as (Source, Destination) grouped log data 262. For example, raw log data may be parsed to extract all log items pertaining communication between two entities based on a source IP address and a destination IP address. Referring to FIGS. 3A and 3B, for example, all data pertaining to communications between a specific source IP address 310 and a destination IP address 320 may be extracted from the logs.

FIG. 3C shows an example entity-pair event record 390 obtained after preprocessing, which may comprise of several items of data pertaining to communication between a source IP address J.K.L.M and a destination IP address X.Y.Z.W pair. In some embodiments, during log foundation model pre-training, entity-pair records may be obtained from network logs across a large number of entity-pairs in IT system 100. In some embodiments, as shown, in FIG. 3C, while each entity-pair record 390 is grouped by the entity pair Source IP Address 310 (J.K.L.M) and Destination IP Address 320 (X.Y.Z.W), the IP addresses themselves (i.e. Source IP Address 310 and Destination IP Address 320) are stripped from entity-pair event record 390. Stripping IP address from the event sequences facilitates focus on event flows and generalized learning that is not dependent on IP address specifics.

In some embodiments, the processing of raw logs to obtain event records by IP address pairs may occur using SPARK. SPARK is an open-source framework designed for large-scale, in-memory data processing, which can offer substantial speedup during pre-processing.

Referring to FIG. 2A, in some embodiments, in Tokenization & Embedding block 210, event stream 204 which includes {204-1 . . . 204-N, 206 (masked events)} may be input to Tokenizer 275.

FIG. 2C shows a flowchart of a tokenization method 270 associated with example tokenizer 275 for tokenization of an event stream. In some embodiments, event stream 274, which may comprise N events in (Source, Destination) grouped log data 262 (e.g. output by preprocessing method 250) may be input to Tokenizer 275. For example, event stream 274 may include N entity (Source, Destination) pair event records 390.

In addition, log specific dictionary 258 may also be input to tokenizer 275. As outlined above, log specific dictionary 258 may include a log specific vocabulary. In some embodiments, based, at least in part, on a focus on cybersecurity related logs (e.g. as reflected in log specific vocabulary in log specific dictionary 258), pre-training tokens T are developed by Tokenizer 275 to emulate meaningful “words” to describe the types of events occurring in event logs. These adapted tokens facilitate comprehension of the sequential nature of events in log foundation model training flow 200 (FIG. 2A).

Thus, in some embodiments, Tokenizer 275 may tokenize input stream 274 based on the specific cybersecurity related (e.g. NetFlow, VPC, DNS, and/or TCP/IP stack) domain data as reflected in log specific vocabulary in log specific dictionary 258. For example, as outlined previously, log specific vocabulary may capture or reflect event sequences and account for fields containing continuous variable and categorical variables. Accordingly, each token generated by Tokenizer 275 may encapsulate categorical and numerical features that define a NetFlow event. This tokenization allows the model to express the details of what occurred in each event concisely, facilitating accurate classification and understanding of network behaviors. Moreover, because numerical data in log files was normalized and binned before being integrated with categorical data, the tokenization is cohesive capturing informative aspects of the data, enhancing the model's ability to detect and classify cyber threats effectively and reducing downstream log volume. In addition, event embeddings 216, which are applied to the token stream facilitate maintenance of context within events.

In some embodiments, tokenizer 275 may use log specific vocabulary in log specific dictionary 258 to tokenize input event stream 274 and output an unmasked tokenized event sequence 277 which may be represented as {CLS, EiTj| where 1≤i≤N and 1≤j≤M}={CLS (202), E1T1 (205-11), E1T2 (205-12) . . . E1TM (205-1M), E2T1, E2T2 . . . E2TM . . . ENT1, ENT2 . . . ENTM (205-NM)}.

During tokenization, Tokenizer 275 may add a special classification token CLS 202 to the beginning of each input sequence. In some embodiments, a “header” token that includes significant non-sequential data may also be used. The CLS (classification) token 202, in BERT, aggregates contextual information from all other tokens through self-attention, and may be seen as representing the entire event sequence for downstream tasks like classification or sentiment analysis. The final (hidden) state of CLS token 202 serves as a summary vector.

In some embodiments, Tokenizer 275 may be adaptive and adjust dynamically to variations in logs. Adaptive tokenization, as used herein, refers to the capability of Tokenizer 275 to accommodate changes in the structure, schema or content of the log data without requiring a complete retraining of log foundation model 200. For example, when a new log source is onboarded (e.g., a new cloud provider's VPC flow logs) or when an existing log source changes its schema, the tokenizer may detect previous values and map them to existing tokens. In addition, the dictionary 258 may be periodically updated to incorporate new vocabulary entries derived from newly encountered log formats, enabling log foundation model 200 to process evolving log sources without full retraining. In some embodiments, the adaptive tokenizer may use a normalization layer that maps vendor-specific field names and value encodings to a canonical representation before tokenization, thereby absorbing schema variation at the tokenization stage rather than propagating it to the model. Thus, adaptive tokenizers 275 may be capable of adapting to and tokenizing distinct event logs (e.g. DNS, NetFlow, VPC, etc.) without the need to retrain underlying log foundation model 200. Adaptive tokenization may, thus, facilitate quick response by log foundation model 200 to changes in cybersecurity logs (e.g. because of reporting changes, updates, changes to logging mechanisms, new tools, etc).

In some embodiments, event stream 204, for all entity pairs (e.g. in (Source, Destination) grouped log data 262) may be streamed to the foundational model using Kafka. Kafka is an event streaming platform that may be used to stream entity pair event records 390 to the foundational model. The term streaming refers to the continuous, real-time ingestion, processing, and consumption of Kafka related “data events” as they occur. In some embodiments, event streams and other information may be stored in high speed storage such as Non-Volatile Memory Express (NVMe), which is a high-performance storage access protocol used with solid-state drives (SSDs) and offers significantly lower latency, faster data transfer speeds, and supports massive parallel command queues.

Referring to FIG. 2A, in some embodiments, in block 210, event stream 204 (e.g. entity pair event record 390) may be input to Tokenizer 275 during a learning phase. Accordingly, event stream 204 (e.g. Event-1 204-1, Event 2 204-2, . . . (Event) MASK 206 . . . Event 31 204-31, Event N 204-N) may be tokenized by Tokenizer 275. In some embodiments, some fraction or percentage of the events in event stream 204 may be masked. In some embodiments, the masking may occur after tokenization by Tokenizer 275. Accordingly, Tokenizer may generate Tokenized event sequence 277-M, where tokens pertaining to one or more events in the event stream 204 may be masked. Tokenized event sequence 277-M may be represented as {CLS, E1T1, E1T2 . . . E1TM, E2T1, E2T2 . . . [MASK] . . . E2TM . . . ENT1, ENT2 . . . ENTM}, where [MASK] represents the masked events. When an event is masked all tokens for that event are masked. Accordingly, if an event q is masked then MASK={Kq1, Kq2, Kq3 . . . KqM}. where Kq represents each masked token in event q. Masked events may be predicted by the foundation model at a later stage during training and compared with the real data with a loss function based on the prediction error being used to increase the accuracy of predictions as explained further below. In some embodiments, some random percentage of events may be masked.

The CLS token 202 may be viewed as holding an aggregated understanding of the entire event sequence and may allow the model to understand context behind the overall sequence. Consequently, upon completion of pre-training, the pre-trained log foundation model 200 model can be fine-tuned with just one additional output layer. The term “fine-tuning” refers to the pre-trained log foundation model 200 (e.g. which already understands log language model patterns), to train it further on a smaller, labeled, task-specific dataset. Fine tuning adapts the model for specialized tasks like classification with high accuracy without the need for substantial task-specific architecture modifications and is described further below.

Further, event embedding 216, positional embedding 217 are performed on the tokenized event input stream EiTj, above, where I={i|1≤i≤N) and J={j|1≤j≤M). In some embodiments, temporal embedding 25 may also be optionally performed on the tokenized event input stream EiTj.

Positional embedding 217 adds information about the position of each event token EiTj over the entire EiTj, input sequence, for all i, 1≤i≤N, and all j, 1≤j≤M) input sequence. Thus, the positional context represented by positional embedding 217 is over the entire event sequence (N event, M tokens per event).

Event embedding 216 provides log foundation model 200 with information about an event's position (e.g. one of 1, 2, 3 . . . N) in the event sequence. For example, event embedding 216 may associate all tokens EkTj in a single event with the same positional embedding reflecting that event's position (e.g. k) in the event sequence. For an event Ei=k, event embedding provides the model with information about the position of event Ek in the event sequence. For an event Ek, all tokens EkTj, for all j|j=1≤j≤M, have the same position information associated with them.

Temporal embedding 215 adds time information to the event tokens EiTj in the input sequence. For example, position vectors and event vectors may be added to event token embeddings EiTj in the input sequence before they enter the attention layer 220. In embodiments where event token embeddings are also augmented with temporal embedding information, position vectors, event vectors, and temporal vectors may be concatenated with event token embeddings EiTj in the input sequence before they enter the attention layer 220.

In some embodiments, temporal embeddings may be based on and/or otherwise reflect time durations between two events such as an Event i 204-i and an Event j 204-j. Positional embedding 217 provides sequential order information, which facilitates understanding of the relative or absolute position of event tokens which facilitates positional differentiation and structure capture.

In Attention block 220, multi-head attention 225 computes attention multiple times in parallel on the same input, allowing the model to jointly attend to information from different representation subspaces. Multiple self-attention mechanisms are run in parallel and capture different aspects of how events relate to each other. The embeddings input to multi-head head attention 225 from block 210 are projected into three different vectors Queries 223, Keys 222, and Values 221 multiple times by using three distinct learned weight matrices. The Queries 223, Keys 222, and Values 221 vectors are created by multiplying input word embeddings by three distinct, learned weight matrices within the self-attention mechanism. They enable the model to determine which tokens to focus on, where Queries 223 may be viewed as the representing the current token searching for context, Keys 222 may be viewed as representing how each token describes itself to determine relevance, and Values 221 may be viewed as containing the actual information to be passed forward.

Multi-Head Self-Attention 225, thus, enables focus on different positions of the input sequence facilitating capture of intricate relationships between events. By processing multiple heads that attend to information from different representation subspaces at different positions, the ability to discern complex patterns and anomalies is enhanced. Attention block 220 facilitates via self-attention (e.g. using multi-head attention 225), the learning of associations between data points including dependencies that may be contextually distant thereby contributing to heightened accuracy. Multi-Head Self-Attention 225, thus, enables capture of relationships between distinct events as well as relationships between fields within an event.

In some embodiments, multi-attention 225 may use or allow invocation of the PyTorch FlexAttention API, which facilitates faster experimentation and rapid prototyping of custom attention masks and score modifications without writing graphics processing units (GPU) or CUDA kernels by accelerating iteration on domain-specific attention patterns.

Flex attention may facilitate rapid experimentation with custom attention masks tailed to the structure of log data. For example, FlexAttention may facilitate experimentation with attention masks that restrict attention to events within the same temporal window, or that apply causal masking to enforce temporal ordering constraints, without the overhead of writing custom GPU kernels for each variant. This may accelerate iteration on domain-specific attention patterns and enable systematic evaluation of which attention structures yield the best detection performance. During deployment, FlexAttention may facilitate the implementation of attention modifications that adapt to characteristics of the deployed environment, such as masking attention across entity-pair boundaries when processing batched sequences from multiple entity pairs simultaneously. When deploying on new infrastructure or when log file formats change, FlexAttention may facilitate the rapid prototyping and testing of modified attention patterns that accommodate new log structures (e.g. different field orderings, new event types) without requiring changes to low-level GPU code, thereby reducing the time required to adapt the deployed model to infrastructure or logging changes.

In some embodiments, Add & Norm 227-1 combines the original input (i.e. the embeddings input to multi-head head attention 225 from block 210) with multi-head attention output and normalizes the results. This facilitates stable training, speeds up convergence, and prevents vanishing gradients promoting effective learning. Adding the original input ensures that the information in embeddings input to multi-head head attention 225 (from block 210) is not lost by transformation in multi-head attention 225. Normalization of the output may give it a zero mean and a standard deviation of 1 to stabilize feature distribution. “Skip Connection” facilitates the flow of gradients during training and helps to mitigate the vanishing gradient problem in deep networks.

In Feed Forward block 230, the normalized output of Add & Norm 227-1 is input to Feed Forward Network (FFN) 235. FFN 235 creates a new representation by introducing non linearity. In some embodiments, Rectified Linear Unit (ReLU) may be used as an activation function. A first layer in FFN 235 may project the input to a larger hidden space resulting in dimensional expansion to which ReLU is applied. The ReLU function, which may be represented as max(0, x), introduces non-linearity and zeroes out negative values resulting in sparse activations, which improve computational efficiency. The expanded dimension representation is then projected back to the original model dimension.

Add & Norm 227-2 then combines the input to block 230 (from Add & Norm 227-1) with FFN output 235 and normalizes the results, which are fed to Prediction block 240.

In some embodiments, Prediction & Loss block 240 may predict the tokenized masked events T_{mask_i} (e.g. MASK 206 from block 210) that were masked (in block 201) based on the other non-masked tokens {[CLS], T₁, T₂, . . . Tₙ}(e.g. output from Add & Norm 227-2). For example, all tokens related to one or more events 206 that were masked (e.g. in block 210) may be predicted by Prediction & Loss block 240 based on other unmasked tokens (e.g. output from Add & Norm 227-2).

In some embodiments, based on the predictions of masked tokens, a cross-entropy loss may be calculated for all the masked tokens. The model generates a probability distribution over the vocabulary for each masked token T_{mask_i} and the cross-entropy loss from each of the model's predictions drive the learning process and generate self-supervisory signals. The cross-entropy loss function may measure the discrepancy between the predicted probability distribution and the actual ground truth token for every masked position. Cross-entropy loss may increase as the predicted probability diverges from the actual label.

In some embodiments, a gradient of the cross entropy loss may be determined for each parameter (or weight) in log foundation model training flow 200 and the gradients may be used to update the weights of log foundation model 100, improving predictions and decreasing the loss for the next iteration.

In some embodiments, the model 200 may be deemed to have been pre-trained when predictions stop improving significantly and the error between predicted outputs and true tokens is minimal. Pre-trained log foundation model 200 may then be fine-tuned for specific tasks.

In some embodiments, log foundation model 200 may be an encoder based model without a decoder when used with a classifier for retrieval, classification, and anomaly detection tasks. Encoder based models without decoders can exhibit considerable compute-efficiency over models that use decoders. Accordingly, in the encoder-based approach without a decoder, the model produces contextualized event representations from the input event sequence. Log foundation model 200 may employ cross-event contextual attention, wherein each event's representation is computed with respect to all other events in the event sequence. Log foundation model 200 differs from conventional BERT language models in at least the following respects: (1) the (next sentence) prediction component is absent; (2) each event in the input sequence is represented as a composite embedding derived from the event's constituent fields (e.g. protocol, source port, destination port, etc.) (as opposed to than from sub word or character-level text tokens); (3) an event embedding layer and a temporal embedding layer that are used in conjunction with a positional embedding layer; and (4) implementing a vocabulary tailored specifically for network logs, enabling the model to better understand logs over time. The above are merely some examples of differentiation and the aspects listed are not intended to be an exhaustive recitation of all distinctions.

In some embodiments, decoders may be added to foundation model 200, for example, when generative aspects are desired.

In some embodiments, because core event patterns may be similar (e.g. entities exchanging information→sequences→tokens→transformer) across various log files, the same pre-trained log foundation model 200 may be used across different log files using adaptive tokenizer 275 (outlined above), which may tokenize logs appropriately based on whether the logs are NetFlow, Web Application Firewall (WAF), DNS, or endpoint logs. In other words, a different tokenization mechanism (e.g. adaptive tokenizer 275) may be used with the same pre-trained log foundation model 200 to process a variety of log files without changes to or retraining of the underlying pre-trained log foundation model 200.

In some embodiments, log foundation model 200 may be pre-trained on benign data (i.e. data considered “normal” or lacking threats). Training on benign data may ensure a robust understanding of normal behavior patterns. Log foundation model 200 pre-trained on benign contexts may have the capacity to discern deviations from established normal behavior, thereby enabling it to identify new attacks. By learning “normal” well, log foundation model 200 not only understands malicious but also what benign looks like in that environment. Learning normal well enables reducing false positives, fewer alerts, less analyst fatigue, and high-fidelity signals. In addition, pre-training on benign data may facilitate detection of zero-day attacks, where no prior signature or labeled example exists, because the model identifies the anomaly based on deviation from learned normalcy rather than matching against known attack patterns. In some embodiments, log foundation model 200 may be trained on log data that includes benign data, threats, and attack sequences with downstream trained classifiers being used to make classifications.

As outlined above, log foundation model 200 may be pretrained and self-learning so that it may be trained on data without labels using patch-based masking (described above). This enables large-scale training on raw NetFlow, VPC and/or other log data and building generalized representations. These generalized representations may be transferred to downstream classifiers as described further below.

For example, in some embodiments, log foundation model 200 may also be trained on a dataset comprising multiple user profiles using common protocols like HTTP, HTTPS, FTP, SSH, and email. The training datasets may capture patterns of normal activities. In some embodiments, the training dataset may also capture methodically executed cyber-attacks such as those described in Table 1 below.

In some embodiments, log foundation model 200 may be trained on distributed systems using multiple GPUs across multiple nodes. For example, a Distributed Data Parallel (DDP) approach may be used, where each GPU holds a complete copy of the model and data is split into batches (parallelized), with gradients being synchronized across all GPUs after each model iteration. In some embodiments, automated mixed precision techniques may be leveraged to speed up training by using lower precision for most operations and enabling full precision for certain operations.

In some embodiments, full shard data parallelism (FSDP) may be enabled to partition both the model and data space for long-context runs, large-batch runs, or when nodes exhibit small Virtual Random Access Memories (VRAMs).

In some embodiments, when frozen log foundation model 200 is deployed (after initial pre-training), Low Rank Adaptation (LoRA) may be used to fine tune and speed up model deployment. LoRA adapters are lightweight, plug-and-play modules used that can efficiently fine tune models (e.g. log foundation model 200) by training a tiny fraction of parameters. LoRA freezes the original model weights and injects small, trainable low-rank matrices into each layer, which facilitates fast, cost-effective customization on new environments or to deal with environment changes. In instances, when a single log foundation model 200 (e.g. deployed on a cloud) serves multiple downstream clients, client-specific LoRA adapters may facilitate client specific tasks/classifier fine tuning.

In some embodiments, pre-trained log foundation model 200 may serve multi-head classifiers. The term multi-head classifier refers to a plurality of classifiers operating simultaneously using a single frozen pre-trained log foundation model 200. The multi-head classifiers facilitate fine tuning for newly discovered threats or use cases without changes to the frozen pre-trained log foundation model 200. In conventional approaches, where the entire model has to be re-trained, the process may take several months.

Accordingly, in some embodiments, a semi-hierarchical approach may be used to run “versions” of pre-trained log foundation model in concert. The term semi-hierarchical refers to a flat (single) pre-trained log foundation model 200 that serves several multi-level classification task heads to handle data that may exhibit an underlying hierarchy (e.g. cyber threat categorization). The “versions” of the pre-trained foundation model may, for example, use one or more distinct classifiers (e.g. not present in other instances).

In addition, when deployed to new environments (e.g. associated with new tenants/clients/customers and/or a new network subsystem for an existing IT system), LoRA adapters may capture local topology for the new environments with the need to retrain log foundation model 200. Accordingly, in some embodiments, deployment of pre-trained log foundation model 200 is quick, painless, and cybersecurity threat coverage can start upon deployment.

In some embodiments, LoRA modules associated with log foundation model 200 may be hot swapped to facilitate different specialized tasks. The term “hot swap” refers instantly switching between different specialized, lightweight, trained modules on a base AI model during inference, without needing to reload the entire model or pause the system.

For example, a first LoRA adapter may be trained for anomaly detection on NetFlow data from a financial services client whose network is characterized by high-frequency, low-latency trading traffic, while a second LoRA adapter may be trained for a healthcare client whose network is characterized by periodic large data transfers associated with medical imaging systems. Upon deployment (e.g. when performing inferencing), when log foundation model 200 receives event streams from the financial services client, the corresponding first LoRA adapter may be loaded and applied to the frozen base model. When event streams from the healthcare client are subsequently received, the first LoRA adapter may be swapped out and the second LoRA adapter loaded, without reloading or reinitializing the base model weights. In some embodiments, hot swapping may also be used to switch between task-specific LoRA adapters on the same client environment, such as switching between an adapter fine-tuned for lateral movement detection and an adapter fine-tuned for data exfiltration detection, depending on the current threat posture or analyst priorities.

In some embodiments, during deployment, inferencing may run at lower precision (e,g 16-bit), use static padding/packing to enable fixed input length, use a recorded sequence of GPU commands (e.g. CUDA graphs) to lower overhead, and dynamically batch input requests to improve efficiencies.

These modifications allow the model to handle logs of diverse schemas and types which in turn is important for transfer learning, resilience to log instability, and Active and Federated learning. The model employs a multi-layer transformer-based architecture, allowing it to capture the sequential and contextual relationships of log entries, further allowing the model to better see anomalies including likely security attacks.

A challenge in cybersecurity analytics is the overwhelming volume of log data, much of which is benign and unrelated to security threats. This data can be expensive to retain and can be technically challenging to rapidly ingest and index. In some embodiments, log foundation model 200 may serve as an intelligent log data filter by enabling storage of data identified as anomalous, which can be a small fraction of the overall log data. For example, in some embodiments, based on an anomalous indication from log foundation model 200, the output embeddings for detected anomalies may be stored or archived. For other, non-anomalous event sequences, log data may be discarded, or temporarily stored and automatically deleted after a short pre-determined period.

Upon deployment of pre-trained log foundation model 200 within a cybersecurity framework, the model analyzes sequential traffic flows to pinpoint both known threats and unusual patterns indicative of novel attacks. In sum, the above techniques, individually, or in combination, enable fast fine tuning, improve adaptability of the deployed log foundation model to multiple tasks, while remaining computationally efficient and fast.

In some embodiments, log foundation model 200 may detect and flag anomalies in an input event sequence. For example, for each output token in the output embedding, a corresponding distance relative to the corresponding input token in the input embedding may be determined. The term “distance” may reflect how close or how similar an input token (in the input embedding) is relative to a corresponding output token (in the output embedding). For example, for each event position in the input sequence, the model may generate a probability distribution over the domain-specific vocabulary representing the likelihood of each possible token being at that position, conditioned on the surrounding events. The position at which the actual token appears in the model's ranked predictions may be identified as a prediction rank for that token. A higher prediction rank may indicate that the event is unexpected given its surrounding context. In some embodiments, an aggregate anomaly score may be determined by aggregating the prediction ranks across all token positions in the sequence (e.g. a sum of prediction ranks). If the aggregate anomaly score exceeds a predefined threshold, log foundation model 200 may flag the event sequence as anomalous. Additionally, or alternatively, the contextualized embedding produced by the model for a given event sequence may be compared against a reference embedding representing learned baseline behavior for the corresponding entity pair. A distance metric such as cosine distance or Euclidean distance may be used to quantify the dissimilarity between the event sequence embedding and the reference embedding. If the distance exceeds a predefined threshold, log foundation model 200 may flag the event sequence as anomalous.

As outlined above, once pre-training is complete, log foundation model 200 may be fine-tuned for specific environments and tasks and deployed. After pre-training, one or more lightweight classifier heads may be trained on top of the frozen base model's embeddings. During classifier training, base model weights are frozen and only classifier head parameters are updated, requiring substantially fewer labeled examples than training from scratch. Multiple heads may be trained for different tasks binary anomaly detection, multi-class attack type classification, entity type identification all sharing a single base model forward pass for multi-task inference.

In some embodiments, the learned embeddings in deployed log foundation model 200 capture behavioral signatures facilitating entity resolution. The learned embeddings may include, communication rhythm, volume patterns, protocol usage, which can persist across IP rotations, proxy usage, and host-hopping. Accordingly, when two distinct IP pairs exhibit similar embedding trajectories, the behavior can be resolved to the same underlying actor (despite IP address pair differences). In some embodiments, the self-supervised pretraining objective facilitates learning of “how an entity communicates” rather than relying on static identifiers (e.g. IP addresses). Conventional approaches lack such a representation layer capable of behavioral fingerprinting across sessions.

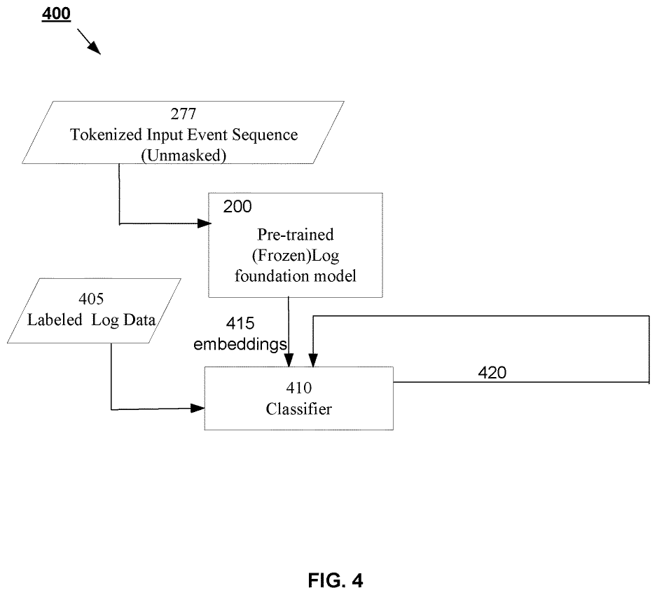

FIG. 4 shows an example and classifier architecture and classifier training flow 400 for classifiers associated with log foundation model 200. FIG. 4 shows training flow to train classifiers 410 using a single pre-trained log foundation model 400. As shown in FIG. 4, base pre-trained (or frozen) log foundation model 200 may be used to fine-tune classifier 410 for specialized tasks. All references to log foundation model 200 when used in relation to the description of FIG. 4 refer to the pre-trained log foundation model 200

As shown in FIG. 4, a tokenized input event sequence 277 is input to log foundation model 200, which may output (a) the final encoder layer output or contextualized embeddings. For example, in some embodiments, log foundation model 200 may output token vectors. For example, for each input token, log foundation model 200 may output a multi-dimensional (e.g. 768 dimension) hidden-state vector that represents an input token (EiTj) in that specific context. In addition, log foundation model 200 may output the special [CLS] token (placed at the beginning of the input), which serves as the representation of the entire input log item. Embeddings 415 output by log foundation model 200 refers to both the contextualized embeddings and the output CLS token. In some embodiments, log foundation model 200 may further return outputs (hidden states) from all intermediate encoder layers.

As outlined previously, in some embodiments, the adaptive and predictive tokenization approach may encapsulate numerical and categorical data associated with a log entry into one or more tokens that concisely represent the features of that entry (e.g. protocol, ports, byte volumes, duration). These tokens, after being processed by the cross-event contextual attention mechanism in log foundation model 200, yield contextualized event embeddings that capture the context and semantic relationships between events within the sequence. In some embodiments, the [CLS] token 202 may aggregate information across all events in the sequence to produce a single embedding vector that represents the entire (e.g. entity-pair) event sequence. The per-event contextualized embeddings may be used for event-level tasks such as identifying specific events in a sequence that may be anomalous, while the [CLS] 202 embedding may be used for sequence-level tasks such as classifying an entire event sequence as benign or malicious. Both types of embeddings may facilitate downstream tasks including anomaly detection, attack type classification, and entity resolution.

Embeddings 415 are input to Classifier 410. In some embodiments, each classifier 410 (e.g. trained using process 400) may perform a distinct specialized classification task upon completion of training/fine-tuning.

Classifier 410 may also receive corresponding labeled log data 405. Labeled log data 405 may include labels, where each label may be associated with a corresponding event in log data 405. In addition, each label may correspond to an event in tokenized input event sequence 277.

While shown separately in FIG. 4, in some embodiments, labels and tokenized input event sequence 277 may be stored together in a single indexed row in a Dataset file and may be separated when input to send the tokenized input event sequence 277 and index to foundation model 200 and the corresponding labeled log data and index to classifiers 410. The labels corresponding to the tokenized event input sequence 277 may be used by a classifier at the time the classifier computes its loss function 420. In some embodiments, the input data may be batched so that N tokenized sequences and corresponding labels are input at a time.

In some embodiments, labeled event input sequences may be obtained using a diverse set of datasets. These may include: (1) publicly available NetFlow datasets containing simulated attacks such as Canadian Institute of Cybersecurity-IDS (CIC-IDS2017 or variants thereof, University of New South Wales—Network Benchmarking 2015 (UNSW-NB15), University of Queensland—Network IDS (UQ-NIDS, Czech Technical Institute-13 (CTU-13) etc.); and/or (2) internally generated data from custom attack simulations designed to represent modern and evasive tactics; and/or (3) proprietary datasets such as Communications Security Establishment (CSE)-CIC-IDS2018 (CSE-CIC-2018), and/or other proprietary datasets shared by enterprise environments participating in proof-of-concept (POC) engagements and/or (4) synthetic attack traffic generated by emulation frameworks (e.g. CALDERA, Atomic Red Team) in controlled range environments, and (5) analyst-labeled production incidents, or (6) in-house simulations and range data.

In some instances, each dataset may be selected to train classifiers for specific characteristics. For example, public datasets may offer broad coverage of known attacks and labeling consistency. Internal simulation datasets may allow finer control over attack types and behavioral variations. Proprietary real-world data introduces authentic network behaviors, noise, and edge cases not found in simulated or controlled environments. This diversity enhances the model's ability to generalize across different network architectures, attacker tradecraft, and deployment contexts.

In some embodiments, during training classifier 410 may compare its output with the labeled data and compute a corresponding loss 420. In some embodiments, a Cross Entropy loss function may be used to compute the loss 420 for classifier 410.

In some embodiments, classifiers 410 may be deemed to have been trained when predictions stop improving significantly and the error between predicted labels and true labels is minimal.

Trained classifiers 410 may then be deployed (e.g. on system 100, subsystem 110 and/or system 190).

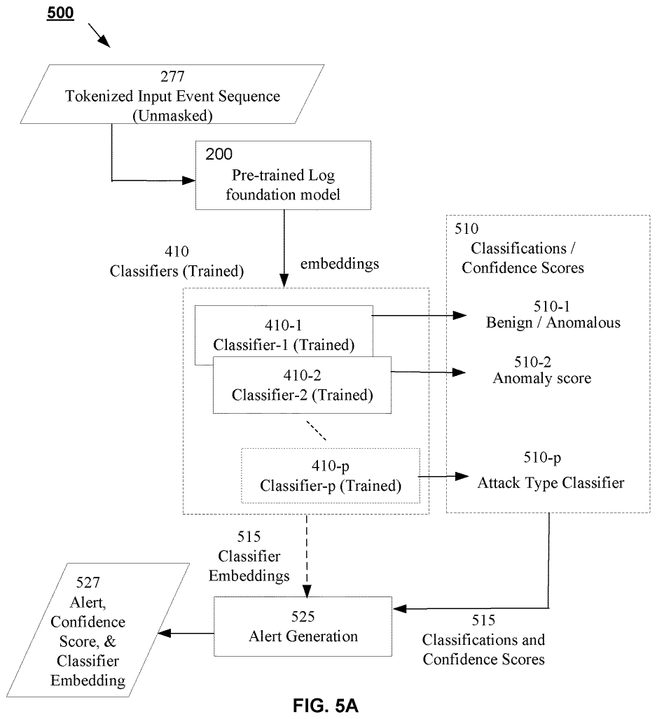

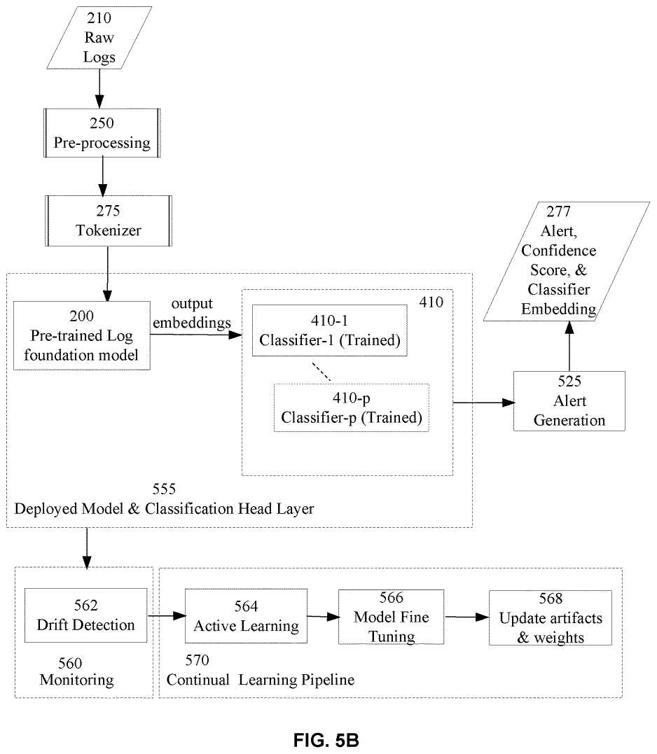

FIG. 5A shows a deployed system 500 comprising a pre-trained (frozen) log foundational model and trained classifiers 410. As shown in FIG. 5A, each classifier 410-k may perform a different specialized task. References to classifiers 410 below in relation to FIG. 5A pertain to trained classifiers.

For example, as shown in FIG. 5A, classifier 1 410-1 may classify an event as benign or anomalous. Classifier 2 410-2 may determine an anomaly score for an event. Classifier 410-p may represent an Attack type classifier.

In some embodiments, Classifier 1 410-1 may flag an event as anomalous by leveraging model knowledge. For example, the likelihood of every event sequence token EiTj in the input sequence for a single event Ei is part of event Ei.

In some embodiments, to determine an anomaly at the event level, Classifier 410-1 may, for each event Ei, predict each token P(Tj) for all M tokens (j=1, 2 . . . M) associated with that event. For each token Tj at position j, a ranked list of token predictions may be generated based on contextual cues from surrounding events in the event sequence. In some embodiments, the prediction rank rj, representing a position at which the actual token Tj appears in the ranked list, may be determined for each token position. For example, if an actual token for j=1 matches the top predicted token at position 1, then prediction rank r1=0. On the other hand, if the actual token for j=1 is 5^{th} on the list of predicted tokens, then prediction rank r1=4. If an aggregate of the prediction ranks across all M token positions for event Ei (e.g. the sum r1+r2+ . . . +rM) exceeds a threshold event, the event may be flagged as anomalous. Otherwise, the event may be deemed benign. In some embodiments, Classifier may output a Benign/Anomaly classification 415 for each event, which may complement the sequence-level anomaly score described above.

In some embodiments, Classifier 410-2 may provide an Anomaly Score that indicates not only the presence but the severity of an anomaly. The Anomaly Score may be derived from one or more of the following: (a) the count of token positions where the top-ranked predicted token P(Tj) does not match the actual token Tj; (b) the prediction ranks rj (i.e. the position at which the actual token Tj appears in the ranked prediction list) aggregated across all M token positions, where higher aggregate rank indicates greater deviation from expected behavior; and/or (c) a similarity measure (e.g. cosine similarity) between the embedding of the top-ranked predicted token P(Tj) and the embedding of the actual token Tj at each position, where lower similarity indicates greater deviation. In some embodiments, Classifier 410-2 may combine (a), (b), and/or (c) into a composite score that provides SOC analysts with a continuous measure of anomaly severity in addition to the binary classification output by Classifier 410-1

Various other trained classifiers 410 may also be deployed. For example, Classifier 410-p may map detected threats to various types of standardized classifications, which may provide further context, for use by cybersecurity analysts. Standardized classifications may include classifications developed by standards bodies, de-facto classifications accepted or prevalent in the cybersecurity community, and/or frameworks based on publicly accessible open source frameworks such as the MITRE ATT&CK® framework.

Example classifications based on a standardized framework (e.g. are shown below in Table 1.

TABLE 1
Example Attack Classifications and Description

| Classification | Summary Description |
|---|---|
| Benign | No threat detected |
| Analysis | Further analysis suggested |
| Backdoor | Unauthorized entry via vulnerable end point |
| Bot | Malicious automated agent |
| Brute Force | Trial & Error method to hack credentials |
| Distributed Denial | Malicious attack to overwhelm |
| of Service (DDoS) | network with a flood of Internet traffic from |
| | multiple sources |
| Denial of Service | Malicious attack to overwhelm network |
| (DoS) | with a flood of Internet traffic from a source |
| Exploits | Malicious use of a security flaw or vulnerability |
| | (bugs, misconfigurations tec.) in software, hardware, |
| | or an operating system |
| Fuzzers | Malicious attempts to detect software vulnerabilities |
| | by injecting malformed, random, or unexpected data |
| | into software inputs to trigger crashes, bugs, or |
| | memory leaks that can be exploited |
| Generic | Common, non-targeted, baseline malicious |
| | techniques such as phishing, using authorized tools, |
| | etc. to gain initial access, persist on the network, or |
| | escalate privileges. |
| Infiltration | Culmination of tactics resulting in an adversary |
| | gaining a foothold inside a network and may flagged |
| | at the time when movement from (external) |
| | reconnaissance to active presence inside the network |
| | occurs or is detected |
| Reconnaissance | Initial, foundational period where adversaries |
| | actively or passively gather information to plan |
| | attacks |
| Theft | Tactics that result in credential access and |
| | exfiltration |
| Worms | Self-replicating malware that autonomously |
| | propagates across networks without host programs |
| | or user interaction |
| Injection | Techniques to execute malicious code within the |
| | address space of a legitimate process |
| Man-in-the- | Attacks or attempts to secretly intercept, manipulate, |
| Middle (MITM) | or relay communications between two unsuspecting |
| | parties |
| Password | Password cracking attempts |
| Ransomware | Tactics where adversaries encrypt files, data, or |
| | systems to withhold access and demand payment |
| Scanning | Adversarial reconnaissance to directly probe a |
| | network to identify live systems, open ports, and |
| | vulnerabilities |
| Cross-Site | Injection type attack where an attacker inserts |
| Scripting (XSS) | malicious scripts (e.g. JavaScript) into content |
| | served to other users by a vulnerable web |
| | application. |

In some embodiments, Classifier 410-p may map one or more of the above detected threats. For example, in some embodiments, upon detection of an anomaly Classifier 410-p may compare a generated embedding represented the event vector against a repository of MITRE ATT&CK technique vectors. In some embodiments, a proximity measure between the event vector and the MITRE ATT&CK technique vectors may be used to identifying MITRE ATT&CK techniques that closely align with the detected anomaly. The proximity or similarities may be scored and/or or ranked and used to classify the threat based on the MITRE ATT&CK framework (e.g. based on the specific MITRE ATT&CK technique that is deemed to match most closely or deemed most similar to the event vector). Classification events based on the MITRE ATT&CK framework facilitates more fine grained threat mapping and provides professionals (e.g. Security Operations Center (SOC) analysts) with a context-rich understanding of the nature and tactics of the attack, informing downstream decision-making and response planning.

In some embodiments, various other threats may be detected and classified. Specifically, based on the capabilities of log foundational model 200 to understand normal or baseline activity through deep-learning, classifiers 410 may detect previously unseen attacks, which may be flagged as anomalous and then classified (e.g. using a trained classifier 410, which may be trained to classify the threat based on labeling from cyber security and/or subject matter experts (SMEs)).

In some embodiments, Classifiers 410 may also generate confidence scores associated with each classification 510. The confidence score for a classification may be based on a proximity measure, a similarity score, or other techniques that reflect how closely an event maps to a classified threat.

In some embodiments, output embeddings from log foundation model 200 may be used perform Exploratory Data Analysis (EDA). In EDA, using techniques such as semantic search, the prevalence of sequences that are most similar to detected anomalies can be determined. For example, similarity measures (e.g. cosine similarity, distance, etc.) may be used to search the multi-dimensional pre-trained log foundation model representation space for sequences similar to a flagged anomalous sequence. In some embodiments, EDA may also facilitate searches based on characteristics of the anomalies, such as those that are similar to a given MITRE ATT&CK classification, or related to particular entity identities.

In some embodiments, classifications and corresponding confidence scores 515 output by classifiers 410 may be sent to Alert Generation block 525. In some embodiments, classifier embeddings 515 may also be sent to Alert Generation block 525. In some embodiments, when the confidence score exceeds some threshold confidence score, Alert Generation block 525 may generate an alert. In some embodiments, the alert may be generated via text, and/or a secure instant messaging app, and/or via e-mail, and/or by updating a dashboard used by a cybersecurity professional. In some embodiments, when a new threat is detected, and/or confidence intervals related to threat are low (although above the confidence score threshold), or in instances where a user has so configured, Alert Generation block 525 may include the confidence score and/or the classifier embedding. In some embodiments, Alert Generation block 525 may associate a unique Alert ID with each alert. In some embodiments, one or more alerts (e.g. received by Alert Generation block 525, and/or acted upon by Alert Generation block 525, and/or selected alerts that are classified for analysis) may be stored in a database. In some embodiments, an alert record in the database may include, alert information, the confidence score, and classifier embedding information 527. In some embodiments, classifier embedding information in alert information, the confidence score, and classifier embedding information 527 may be stored in a Vector database (“VectorDB”).

For example, in some embodiments, the VectorDB may be deployed close to a source of the log data stream, and/or be communicatively coupled to data in a security data lake. Accordingly, MITRE ATT&CK related information, identified entities may be added to alert information, the confidence score, and classifier embedding information 527 and other information about the anomaly and pushed downstream to a SIEM or other system for review by an SOC or cybersecurity analyst.

In some embodiments, the multi-head classifier architecture supports the addition of a lightweight head that maps base model embeddings to specific MITRE ATT&CK technique identifiers (e.g., T1071, T1048). Because the base model already captures temporal attack structure, a relatively small number of labeled examples per technique is sufficient for generalization. The shared embedding space also enables encoding threat intelligence feeds (such as Indicators of Compromise (IoCs), “red flags,” or known campaign signatures) found on networks or devices that indicate a security breach has already occurred. In some embodiments, the encoded threat intelligence feeds may serve as reference vectors facilitating performance of similarity searches against live traffic via the VectorDB. Cross-environment transfer may be facilitated by the shared base model, while per-tenant adaptation can leverage LoRA.

In some embodiments, the embeddings generated in a deployed system 500 may be stored in VectorDB and facilitate post-incident investigation. When provided with a confirmed incident, system 500 may retrieve all sequences involving a resolved entity (even across IP rotations by leveraging entity resolution above), reconstruct the full attack timeline, and identify the precise events where behavior diverged from baseline. The patch-based masking objective (during pre-training) enables per-event anomaly attribution (during inference by pre-trained log foundation model 200). For example, the reconstruction error at each event may be viewed as quantifying how anomalous that event was relative to the model's learned baseline, providing an event-level forensic audit trail.

FIG. 5B shows an example flow for a framework for active learning 550 in conjunction with a deployed system for anomaly detection. In some embodiments, may be implemented on system 100 or a subsystem of system 100 (e.g. cloud subsystem 190).

As shown in FIG. 5B, and described above, Raw Logs 201 may be pre-processed by Pre-processing block 250 and then tokenized by Tokenizer 275. Event tokens may be input to log foundation model 200, which may send output embeddings to multi-head classifiers 410. The output classifications and corresponding confidence scores 515 output by classifiers 410 may be sent to Alert Generation block 525. In some embodiments, classifier embeddings 515 may also be sent to Alert Generation block 525. In some embodiments, when the confidence score exceeds some threshold confidence score, Alert Generation block 525 may generate an alert. Alert generation block 525 may also output alert information, the confidence score, and classifier embedding information 527 and/or store alert information, the confidence score, and classifier embedding information 527 in a database (e.g. using database servers 170, and/or databases 196). In some embodiments, classifier embedding information in alert information, the confidence score, and classifier embedding information 527 may be stored in a VectorDB. In some embodiments, pre-trained log foundation model 200 and classifier 410 may form part of Deployed Model & Classification Head layer 555.

In some embodiments, Drift Detection block 562 may detect drift. For example, when alerts over some time period exhibit a number of false negatives and/or exhibit a number of incorrect classifications (e.g. over some threshold), then Active Learning block 564 may be triggered. In some embodiments, the number of false negatives, or incorrect classifications may be based on input from other detection systems, tools, and/or analyst input, etc. The event labels for the false negatives and/or incorrect classifications may be used to re-train classifiers 410 in model fine tuning block 566 and artifacts and weights for the corresponding classifiers may be updated in block Update Artifacts & Weights block 568. Artifacts refer to tangible files generated and saved after fine-tuning a classifier 410 and may be used to move the classifier 410 to a deployed environment. Once re-trained, the re-trained classifiers 410 may replace the previously deployed classifiers. In some embodiments, Drift Detection block 562 may form part of a monitoring pipeline and Active Learning block 564, Model Fine Tuning block 566, and Update artifacts & weights block may form part of Continual Learning Pipeline 570.

The output embeddings of pre-trained log foundation model 200 reflect a full event sequence (e.g. {E1, E2 . . . EN}) conversation and facilitates threat detection with richer context by identifying the attack stage, involved entities, and temporal progression. The context may support a tiered automated response: high-confidence binary detections can trigger immediate containment (e.g., firewall block); early-stage lateral movement detections can trigger segment isolation; borderline cases may be routed to analysts with the full sequence narrative. The active learning loop may continuously refine response thresholds based on analyst feedback.

A deployed log foundation model 200, consistent with embodiments disclosed herein, may learn combinations and patterns in log files that are contextually (in position and time) separated by significant “distance”. Because of the speed of communications even short (human) times can be long in computer cycles. Thus, log files can be long, difficult to read, and humans typically have a narrow field of view making it difficult to discern threats.

In addition, because of threat mutation and mutation speed, rules-based approaches are limited. For example, in a command and control (C2) attack over commonly used ports (e.g. 443 (HTTPS), 80 (HTTP), or 53 (RSP), a C2 implant may beacon once every 4 hours, send 2 KB upstream, receive a small command payload downstream, and terminate the connection cleanly. Blocking port 443 is not an option, it carries the entire web. Attackers know this, and modern C2 frameworks are built to exploit it. These individual flows are invisible, the volume is below any reasonable threshold, the port is expected, the destination may be a legitimate cloud provider used for domain fronting, and the TLS certificate is valid. Threshold based rules are structurally incapable of catching this because they are designed to trigger on magnitude but the attacker has specifically engineered every event to be below every magnitude trigger.

On the other hand, upon deployment, a pre-trained log foundation model 200 may determine or infer (from training) that (1) the host in question has not been making periodic, low variance, outbound connections to the same destination on a recurring schedule, and/or (2) relate the behavior in (1) to a prior anomalous inbound event that occurred just prior to (1). Thus, log foundation model 200 may correlate seemingly (contextually and temporally) distant events to determine a C2 threat and alert a cybersecurity professional. Log foundation model reads a sequence across time, and recognizes the rhythm and overall sequence of the behavior regardless of the seeming innocuity of any individual data point. In some embodiments, log foundation model 200 may flag a sequence of events as anomalous and then classify (e.g. using classifier 410) the threat as a C2 threat.

As another example, when an attacker logs in with stolen credentials (hijacked password or stolen session token), the login succeeds because there is there is no malware, no exploit, and no process for end point detection and response (EDR) to observe and SIEM may score the action as low risk. In some embodiments, upon deployment, log foundation model 200 may determine or infer (from training) that (1) a first login from a geography not seen in 90 days, (2) a session token issued outside normal working hours, and (3) followed shortly by Graph API enumeration (e.g. accessing Microsoft 365 resources (users, groups, apps, SharePoint sites) at an atypical scale at several times a user's historical baseline. Thus, log foundation model may correlate these events to determine a likely credential theft threat/attack and alert cybersecurity professionals or take other actions. Although no individual event in (1)-(3) above crossed a threshold, the combination, when read as a sequence against a learned model of what this user's network behavior actually looks like, is unambiguous. In some embodiments, log foundation model 200 may build user profiles and flag deviations of user behavior relative to that profile to determine and identify credential threats.

In a “Living off the Land” threat, a competent attacker may switch to built-in Microsoft-signed Windows tools: PowerShell, WMI, certutil, PsExec, Task Scheduler, instead of using malware so that nothing looks unusual in isolation. A domain enumeration command at 9 am is a normal IT task. EDR sees signed binaries executing normally and produces no alert. In some embodiments, upon deployment, log foundation model 200 may determine or infer (from training) that (1) the outbound connection from certutil to a domain registered 48 hours ago is unusual, and (2) the sequence of what those binaries produce on the network such as (a) DNS queries to domains with no prior history, (b) outbound connections to IPs that have never been contacted from this host, (c) protocol distributions that deviate from the host's established baseline and determine the behavior to be anomalous or classify the threat appropriately. In some embodiments, deployed log foundation model 200 infers the anomaly and classifies the threat (“Living of the Land”) based on the event sequence deviating from normal or historical network traffic characteristics (new domains, new IP addresses, protocol distributions).

In a Bring Your Own Vulnerable Driver (“BYOVD”) attack, the detection layer may be the target. A legitimate Microsoft-signed driver with a known memory vulnerability may be used to write zeros over the EDR's kernel callback pointers, and the sensor goes deaf. It keeps running. The dashboard stays green but it does not receive events from that point forward and every subsequent action (e.g. C2 beaconing, lateral movement, data staging) is invisible to EDR.

In some embodiments, deployed log foundation model 200 reads, as its native language, (1) network metadata associated with packets that the C2 beacon places on the network, and determines (a) that the beacon interval, the payload asymmetry, the connection cadence packets from the C2 beacon are anomalous, and (2) recognizes the EDR silence as an anomalous signal. Thus, in some embodiments, based on silence or lower telemetry volume at an endpoint layer in the face of otherwise normal network activity, log foundation model 200 may flag an anomaly associated with a host. In some embodiments, based on deviations in C2 beacon intervals, and/or payload asymmetries, and/or connection cadence irregularities, log foundation model 200 may flag an anomaly associated with a host.

In a “Lateral movement attack” an attacker may pivot from a prior compromised host to a new host and a source IP that previously communicated with a handful of expected destinations suddenly opens connections to new internal hosts (with no prior relationship). Such lateral pivots may be spaced (e.g. days) apart, use legitimate protocols like RDP, WMI, and SMB, and validly authenticate with credentials harvested from the prior compromised host. No authentication failures occur and no malicious tool signatures are seen. In some embodiments, deployed log foundation model 200 may determine, based on implicit conversation graph encodings in its event sequence representation, that new anchor pairs emerging after credential-adjacent events when coupled with changes in host pairs that co-occur frequently carry a high discriminative signal and are anomalous. For example, deployed log foundation model 200 may determine that (1) (a) failed authorization attempts on a host E₃, (b) a successful authorization on a host E₇, and (c) a new outbound connection to a previously unseen internal host E₁₂ are all present in the same attention context. In some embodiments, deployed log foundation model 200 may determine that (a) the credential probing, (b) resolution, and (c) a new lateral edge in the conversation graph are characteristic of pivot behavior, and flag the sequence as anomalous or classify it as a “lateral movement attack.” The threat may be flagged despite the elapse of several days between events.

In some embodiments, log foundation model 100 may be used to detect adjacent attack patterns. Adjacent attack patterns exploit vulnerabilities from a shared physical or logical network to compromise a target and, typically, do not occur from an external, remote location such as the Internet. Log foundation model 200 may be used with classifiers to facilitate Data Loss Prevention (DLP) and other insider threats. For example, in a “Low-and-slow exfiltration,” a sophisticated actor will move small (below threshold) volumes of data (e.g. 20 MB) per day to a cloud storage endpoint over 30 days so that (a) each individual flow is indistinguishable from a legitimate backup or sync, (b) no single event crosses any volume threshold and (c) no destination is inherently suspicious. In isolation, every data point is benign.

In some embodiments, deployed log foundation model 200 reads the sequence of events across the full temporal window and may recognizes (1) the accumulating pattern, (2) the consistent destination, (3) a consistent internal source, (4) a slowly climbing cumulative transfer, and may ties these to other preceding upstream events such as (a) recon activity, (b) lateral movement to the host containing the sensitive data, and (c) the staging behavior. In some embodiments, by correlating actions from a user associated with a source and destination over a time period with user actions (recon, lateral movement, staging) in a time window preceding that time period, log foundation model 200 may infer anomalous behavior such as exfiltration actions and raise alerts. Log foundation model 200 raises the alerts because the entire ordered chain of events leading to and including the transfers matches the structure of exfiltration campaigns compressed during training. Threshold rules, which focus on individual events, cannot encode actions that involve memory of events over a time period.

In AI-powered attacks, adversarial ML tools generate traffic that mimics the statistical profile of legitimate user behavior randomizing user agents, mimicking browser TLS fingerprints, varying request timing. Classical anomaly detection using per-feature thresholds or shallow ML fails because it looks at individual feature distributions in isolation.

In some embodiments, deployed log foundation model 200 reads a sequence of events across a full time window to predict a likely next event for a host. When the predicted event, based on the entire prior sequence, differs markedly from the prediction, an anomaly may be flagged. Because deployed log foundation model 200 reads the entire causal chain of a legitimate user session the DNS lookups that precede HTTP, the authentication events, the access patterns consistent with a human work schedule and has internalized those co-occurrence and ordering constraints, an adversarial AI-generated traffic sequence (that passes per-event inspection) may exhibit ordering violations that sequence attention in deployed log foundation model 200 will flag. Model 200 does not look merely at the normality of a single flow. Instead, the inference looks at host actions over some time period (e.g. 6 hours,) to determine whether the next event differs from a predicted event.

In “Multi-stage attack chain events” a MITRE ATT&CK kill chain such as Initial Access→Discovery→Lateral Movement→Collection→Exfiltration, may unfold across multiple hosts and be logged as hundreds of log events, often over days or weeks. No individual stage may be alarming on its own such as a not uncommon noisy port scan from an internal host; a single unremarkable Server Message Block (SMB) authentication failure (a client attempts but fails to connect to a resource because of invalid credentials); a file copy to a staging directory is invisible. Classical SIEM correlation rules can link 2 or 3 events with hand-written logic, but encoding the full combinatorial space of multi-hop, multi-day kill chains in rules is computationally intractable—the rule set explodes, and attackers can trivially vary the sequence.

In some embodiments, deployed log foundation model 200 treats the entire observable window as a single sequence and has learned, self-supervisedly, that certain orderings and spacings of event types are predictive of campaign completion. In some embodiments, deployed log foundation model 200 infers anomalies or classifies the attack as “campaign in progress” based on a pattern of (a) recon events (noisy port) followed by (b) credential events (SMB failure) and (c) followed by new lateral edges (file copy) as being tied to a compressed internal representation of “campaign in progress” because the ordering appeared repeatedly in the training distribution and its continuation (exfiltration) lead to model 200 building a compressed internal representation of “campaign in progress.”

In 0-Day and Novel Malware attacks, which exhibit behavioral invariance across exploit novelty, attackers have critical structural advantages. A 0-day, by definition, has no signature. EDR solutions that rely on file hashes, syscall signatures, or known shellcode patterns are blind at the moment of exploitation. But after a successful 0-day exploit, the attacker still has to do something—and that something requires network behavior. They need to establish C2. They need to move laterally. They need to exfil data. These post-exploitation behaviors are not 0-days. They are the same behavioral primitives that have existed for decades, constrained by what networks allow, not by what the malware does. The C2 beacon looks the same whether the initial access was via a known CVE or a never-before-seen browser exploit. The lateral movement pattern looks the same whether the tooling was publicly available or custom built.

As outlined above, deployed log foundation model 200 is trained on the entity based network traffic patterns and network artefacts arising from normal behavior and attacks. In contrast, many cybersecurity tools use exploit artifacts so that a brand new piece of malware using a brand new vulnerability will escape many cybersecurity tools. When these brand new vulnerabilities and malware produce network event sequences that fall within the manifold of malicious behavior that deployed log foundation model 200 has already learned, the anomalous behavior raises alerts without the need for any signature updates.

In addition, when IT system 100 topology changes (cloud migration, new services, mergers), the base model's generalized representations degrade gracefully and recover with continued self-supervised updates on new data. In contrast, rule based systems break immediately and require months of manual rewriting.

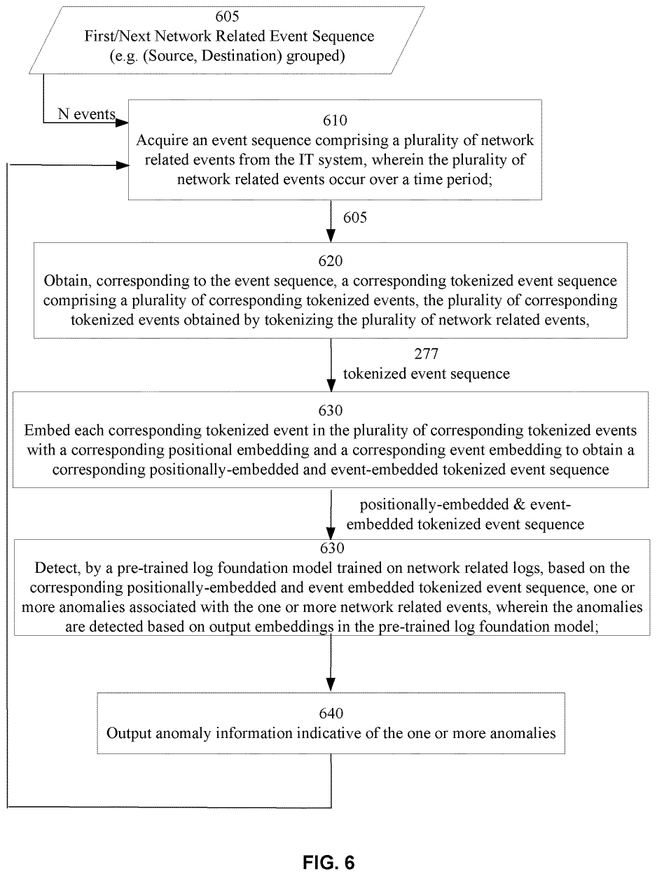

FIG. 6 shows a flowchart of an example cyber threat detection method 600 consistent with embodiments disclosed herein. In some embodiments, method 600 may be performed by one or more computers (e.g. 102) or cloud based virtual machines (e.g. on cloud 190) to detect cyber threats on IT system 100.

In some embodiments, in block 610, an event sequence comprising a plurality of network related events from the IT system may be acquired, wherein the plurality of network related events occur over a time period. For example, input first/next network related event sequence 605 may be acquired. In some embodiments, input First/Next network related event sequence 605 may comprise N network related events, In some embodiments, raw network data may be preprocessed (e.g. by pre-processing block/routine 250) to obtain first/next network related event sequence 60, which may be grouped by entity pairs (e.g. (Source, Destination)). In some embodiments, First/Next network related event sequence 605 may take the form of (Source, Destination) Grouped Log Data 262. In some embodiments, each event in input First/Next network related event sequence 605 may comprise a line in a network log file (e.g. NetFlow, VPC, DNS, etc.) and reflect communication parameters related to the entity-pair (e.g. Source port, Destination port, protocol, forward packets, backward packets, connection state etc.). The above are merely examples, and fields other than those listed above may also be used.

In some embodiments, NetFlow data may be supplemented by enriched network metadata, which may be available using network monitoring tools (e.g. Zeek), which can provide additional context such as application-layer details and connection states. In addition, DNS logs, DHCP records, and firewall metadata can also provide complementary network-level insights. In addition, logs (e.g. used to obtain First/Next Network Related Event Sequence 605) may also comprise one or more of the logs outlined above including VPC logs, DNS logs, logs associated with the TCP/IP stack output by devices, etc.) One or more of the above logs may be used both to pre-train log foundation model 200 and as input to pre-trained log foundation model 200 (e.g. as part of First/Next Network Related Event Sequence 605).

In block 620, corresponding to events in the event sequence (e.g. events in First/Next Network Related Event Sequence 605), a corresponding tokenized event sequence (e.g. tokenized event sequence 277) comprising a plurality of corresponding tokenized events, may be obtained. The plurality of corresponding tokenized events may be obtained by tokenizing the plurality of network related events. For example, in some embodiments, the network related events E in the event sequence may comprise E={E1, E2, E3 . . . EN} and each event EI may be associated with M tokens T, so that the corresponding tokenized event sequence for an event EI={EIT1, EIT2, EIT3 . . . EITM}. In some embodiments, the tokenized event sequence may be obtained by Tokenizer 275 and correspond to tokenized event sequence 277. The tokenized input sequence may include a special classification token [CLS] added to beginning of every tokenized event sequence. In some embodiments, tokenizing the one or more network related events may be based on a custom vocabulary (e.g. in log specific dictionary 258), wherein the custom vocabulary is derived from network log files used to train the log foundation model.

In block 630, each corresponding tokenized event (e.g. EI) in the plurality of corresponding tokenized events (e.g. in tokenized event sequence 277) may be embedded with a corresponding positional embedding (e.g. 217) and a corresponding event embedding (216) to obtain a corresponding positionally-embedded and event-embedded tokenized event sequence. The positionally-embedded and event-embedded tokenized event sequence may include (1) position embedding information indicating the position of each token CLSI and EITJ (e.g. for an event EI) in the event sequence, and (2) event embedding information indicating the event (e.g. EI) that each token CLSI and EITJ is associated with in the event sequence.

Accordingly, in some embodiments, the corresponding event embedding associated with each corresponding tokenized event (e.g. [CLSI], EIT1, EIT2, EIT3 . . . EITM) may be indicative of a position I of an associated network related event EI in the event sequence. In some embodiments, embedding may further comprise embedding the one or more corresponding tokenized events with a corresponding temporal embedding. In some embodiments, the temporal embedding may be optionally performed (e.g. based on whether log foundation model 200 has been pre-trained with temporal embedding information). The corresponding temporal embedding associated with each corresponding tokenized event may be indicative of a time between events in the event sequence.

In block 630, a pre-trained log foundation model (e.g. pre-trained log foundation model 200), which has been trained on network related logs, may detect based on the corresponding positionally-embedded and event-embedded tokenized event sequence, one or more anomalies associated with the one or more network related events, wherein the anomalies are detected based on output embeddings in the pre-trained log foundation model.

In some embodiments, the pre-trained log foundation model 200 may have been pre-trained (e.g. during a pre-training phase prior to deployment) on various logs listed herein. The various types of logs above may also be used to derive input (e.g. used to obtain First/Next Network Related Event Sequence 605) when pre-trained log foundation model 200 is deployed.

In some embodiments, the anomalies may be detected based on a comparison of the output embeddings (e.g. O(EITJ), where O represents the output embedding) by pre-trained log foundation model to the corresponding tokenized event sequence.

For example, for each event position in the input sequence, the model may generate a probability distribution over the domain-specific vocabulary representing the likelihood of each possible token being at that position, conditioned on the surrounding events. The position at which the actual token appears in the model's ranked predictions may be identified as a prediction rank for that token (e.g. where an exact match is position 0, and rank increases with lower likelihood). A higher prediction rank may indicate that the event is unexpected given its surrounding context.

In some embodiments, an aggregate anomaly score may be determined by aggregating the prediction ranks across all token positions in the sequence (e.g. a sum of prediction ranks). If the aggregate anomaly score exceeds a predefined threshold, log foundation model 200 may flag the event sequence as anomalous.

Additionally, or alternatively, the contextualized embedding produced by the model for a given event sequence may be compared against a reference embedding representing learned baseline behavior for the corresponding entity pair. A distance metric such as cosine distance or Euclidean distance may be used to quantify the dissimilarity between the event sequence embedding and the reference embedding. If the distance exceeds a predefined threshold, log foundation model 200 may flag the event sequence as anomalous.

In some embodiments, an anomaly alert may be initiated, when an anomaly score exceeds a threshold value. For example, the anomaly score may be computed by: determining, for each output token (e.g. O(EITJ),) in the output embedding, a corresponding distance relative to the corresponding tokenized event (EITJ) in the corresponding tokenized event sequence (e.g. tokenized event sequence 277) and aggregating the corresponding absolute distance for each output token using an aggregation function.

In block 640, anomaly information indicative of the one or more anomalies may be output.

In some embodiments, as outlined above, the tokenized event sequence for each event EI may include a classification token [CLSI], which appears at the beginning of each tokenized event sequence for event EI. The classification token may facilitate the use of pre-trained log foundation model 200 with additional classifier via fine-tuning (e.g. without retraining frozen pre-trained log foundation model 200).

Accordingly, in some embodiments, the anomalies may be classified into one or more classifications, wherein the classification may be performed by one or more trained classification models based on the output embedding of pre-trained log foundation model 200. In some embodiments, the one or more trained classification models are obtained by fine tuning the pre-trained log foundation model. In some embodiments, the one or more classifications may comprise at least one of anomalies, attacks, or suspicious activity. The term anomaly refers to deviation from learned normalcy (e.g. actual output vs predicted output). The term attack refers to malicious actions (e.g. with a high confidence such as malware execution). The term “suspicious activity” refers to behavior that may indicate a threat (such as privilege escalation, unusual lateral movement, etc.).

In some embodiments, an alert may be generated based, at least in part, on one or more corresponding confidence levels associated with the classification. Further, in some embodiments, at least one classification of the one or more classifications may further comprise an anomaly score indicative of an anomaly level associated with the at least one classification. In some embodiments, the anomalies may be classifier into one or more classifications, which may be determined in accordance with a standardized classification framework (e.g. MITRE ATT&CK). In some embodiments, the alert may include the one or more classifications, a confidence level associated with the classification, and a classification output embedding associated with the classification.

In some embodiments, the output embeddings of a classifier may be used in a continual learning mode by monitoring drift in the anomalies detected by the log foundation model, and in response to a determination that the drift in the anomaly detection exceeds a threshold (e.g. in drift detection block 560), initiating a continual learning pipeline (e.g. 562) to update artifacts and weights associated with the one or more classifiers via fine tuning.

In some embodiments, a system to detect cyber-threats related to an information technology (IT) system (e.g. IT system 100), may comprise at least one computer (e.g. 102, 700) comprising a processor (701), a memory (703), and a network interface (720), wherein the processor may be configured to perform method 600.

In some embodiments, a non-transitory computer readable medium (e.g. 736) may comprise instructions to configure a processor to perform method 600.

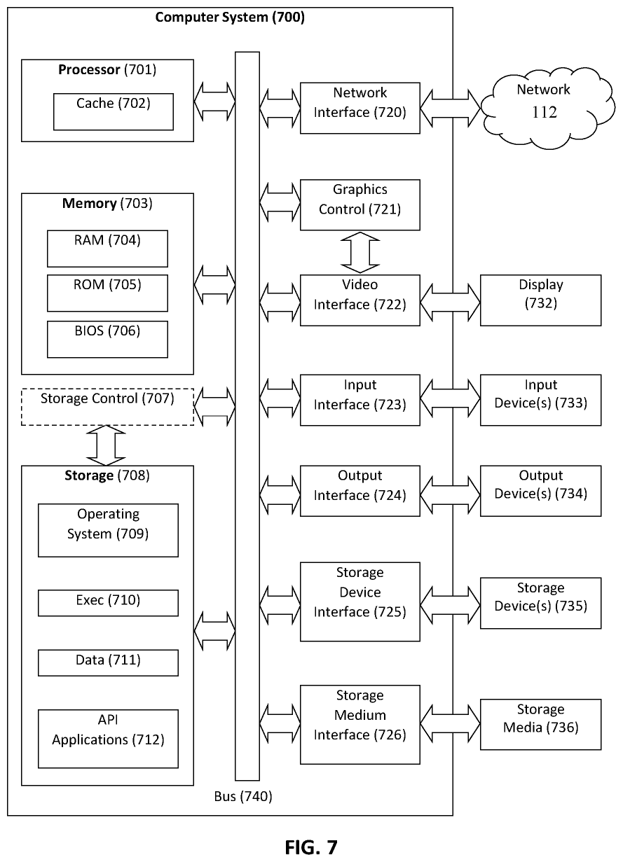

FIG. 7 shows a block diagram is shown depicting an exemplary computer 600. Computer 700 may take the form of a physical device such as laptop 104, workstation 106, and/or another computing device such as a server, etc. In some embodiments, computer 700 may be a virtual machine configured on a cloud and that may leverage an underlying compute infrastructure deployed on the cloud. In some embodiments, one or more computers 700 may be networked (e.g. as in IT system 100) to form an infrastructure. In some embodiments, log foundation model 200 (during training and when deployed), classifiers 410 (during training and when deployed), pre-processor(s) 250, adaptive tokenizer 275, etc. may run on one or more computers 700, such as portions of system 100 and/or subsystem 190 (e.g. a cloud based system, which may be public, private, or a hybrid private-public system), Computer 700 and/or processors 701 in computer 700 may execute or provide functionality for any one or more of the aspects and/or methodologies to implement and run a cybersecurity threat detection system or its components consistent with embodiments disclosed herein. The components in FIG. 7 are examples only and do not limit the scope of use or functionality of any hardware, software, embedded logic component, or a combination of two or more such components implementing particular embodiments.

Computer 700 may include one or more processors 701, a memory 703, and a storage 708 that may communicate with each other, and with other components, via bus 740. Bus 740 may also link to display 732, one or more input devices 733 (which may, for example, include a keypad, a keyboard, a mouse, a stylus, etc.), one or more output devices 734, one or more storage devices 735, and various tangible storage media 736. All of these elements may interface directly or via one or more interfaces or adaptors to the bus 740. For instance, the various tangible storage media 736 can interface with the bus 740 via storage medium interface 726. Computer 700 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer 700 may include one or more processor(s) 701 (e.g., central processing units (CPUs), and/or or graphics processing units (GPUs), and/o tensor processing units (TPUs) and or Application Specific Integrated Circuits (ASICs)) that carry out various functions disclosed herein. Processor(s) 701 may include cache memory unit 702 for temporary local storage of instructions, data, or computer addresses. Processor(s) 701 are configured to assist in execution of computer readable instructions.

Computer 700 and/or processor(s) 701 may read and execute non-transitory, processor-executable instructions embodied in one or more tangible computer-readable storage media, such as memory 703, storage 708, storage devices 735, and/or storage medium 736. The computer-readable media may store software that implements log foundation model 200 (during training and when deployed), classifiers 410 (during training and when deployed), pre-processor(s) 250, adaptive tokenizer 275, etc. and processor(s) 701 (including cloud-based processors) may execute the software. Memory 703 may read the software from one or more other computer-readable media (such as external mass storage device(s) 735, 736) or from one or more other sources through a suitable interface, such as network interface 720. The software may cause processor(s) 701 to carry out one or more processes or one or more steps of one or more processes described or illustrated herein. Carrying out such processes or steps may include defining data structures stored in memory 703 and modifying the data structures as directed by the software.

Computer 700 may include memory 703, which may include one or more of: Read Only Memory (ROM), Programmable Read Only Memory (PROM), Random Access Memory (RAM) of various types, Non-Volatile RAM, etc. Memory 704 may be implemented within processor(s) 701 or external to processor(s) 701. As used herein, the term “memory” refers to any type of long term, short term, volatile, nonvolatile, or other memory and is not to be limited to any particular type of memory or number of memories, or type of media upon which memory is stored.

Memory may comprise cache memory, primary memory, and secondary memory. Secondary memory may include computer-readable media such as storage 708, storage devices 735, and/or storage medium 736. Storage medium 736 may include magnetic and/or optical media including removable media such as optical disks such as compact-discs (CDs), laser discs, digital video discs (DVDs), blu-ray discs, and other optical media and may further include USB drives, flash drives, solid state drives, memory cards etc. Computer 700 may further include external storage 735, which may include hard drives, solid state drives (SSDs), flash memory, and other non-volatile storage

ROM 705 may act to communicate data and instructions to processor(s) 701, and RAM 704 may act to communicate data and instructions bidirectionally with processor(s) 701. ROM 705 and RAM 704 may include any suitable tangible computer-readable media described below. In one example, a basic input/output system 706 (BIOS), including basic routines that help to transfer information between elements within computer 700, such as during start-up, may be stored in the memory 703.

Internal storage 708 is connected bidirectionally to processor(s) 701, optionally through storage control unit 707. Fixed storage media may include SSDs, NVMe devices, hard drives, etc. Internal storage 708 provides additional data storage capacity and may also include any suitable tangible computer-readable media described herein. Storage 708 may be used to store operating system 709, executable(s) 710, data 711, applications 712 (application programs), and the like. Storage 708 can also include an optical disk drive, a solid-state memory device (e.g., flash-based systems), or a combination of any of the above. Information in storage 708 may, in appropriate cases, be incorporated as virtual memory in memory 703.

In one example, external storage device(s) 735 may be removably interfaced with computer 700 (e.g., via an external port connector (not shown)) via a storage device interface 725. Particularly, external storage device(s) 735 and an associated machine-readable medium may provide non-volatile storage of machine-readable instructions, data structures, program modules, and/or other data for the computer 700. In one example, software may reside, completely or partially, within a machine-readable medium on external storage device(s) 735. In another example, software may reside, completely or partially, within processor(s) 701.

Bus 740 connects a wide variety of subsystems. Herein, reference to a bus may encompass one or more digital signal lines serving a common function, where appropriate. Bus 740 may be any of several types of bus structures including, but not limited to, a memory bus, a memory controller, a peripheral bus, a local bus, and any combinations thereof, using any of a variety of bus architectures. As an example, and not by way of limitation, such architectures include a Peripheral Component Interconnect (PCI) bus, a PCI-Express (PCIe) bus, serial buses such as the serial advanced technology attachment (SATA) bus, HyperTransport (HTX) bus, serial advanced technology attachment (SATA) bus, and any combinations thereof.

Computer 700 may also include an input device 733. In one example, a user of computer 700 may enter commands and/or other information into computer 700 via input device(s) 733. Examples of an input device(s) 733 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, input device(s) 733 may be interfaced to bus 740 via any of a variety of input interfaces 723 (e.g., input interface 723) including, but not limited to, serial, parallel, game port, USB, FIREWIRE, THUNDERBOLT, or any combination of the above.

In particular embodiments, when computer 700 is connected to network 112, computer 700 may communicate with other devices, specifically mobile devices and enterprise systems, distributed computing systems, cloud storage systems, cloud computing systems, and the like, connected to network 112. Communications to and from computer 700 may be sent through network interface 720. For example, network interface 720 may receive incoming communications (such as requests or responses from other devices) and/or network logs (including NetFlow logs, VPC logs, DNS logs, PCAP data, etc.) over network 112, and computer 700 may store the incoming communications in memory 703 for processing. Computer 700 may similarly store outgoing communications (such as requests or responses to other devices) in memory 703 and initiate transmission of these communications over network 112 using network interface 720. Processor(s) 701 may access incoming and outgoing communications stored in memory 703 for processing.

Examples of the network interface 720 include, but are not limited to, a network interface card, a modem, and any combination thereof. Examples of a network 112 or network segment 730 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 112, may employ a wired and/or a wireless mode of communication. In general, any network topology may be used.

Information and data can be displayed through a display 732. Examples of a display 732 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 732 can interface to the processor(s) 701, memory 703, and internal storage 708, as well as other devices, such as input device(s) 733, via the bus 740. The display 732 is linked to the bus 740 via a video interface 722, and transport of data between the display 732 and the bus 740 can be controlled via the graphics control 721. In some embodiments, the display is a video projector. In some embodiments, the display is a head-mounted display (HMD) such as a VR headset. In further embodiments, suitable VR headsets include, by way of non-limiting examples, HTC Vive®, Oculus Rift®, Samsung Gear VR®, Microsoft HoloLens®, Razer OSVR®, FOVE VR®, Zeiss VR One®, Avegant Glyph®, Freefly VR® headset, and the like. In still further embodiments, the display is a combination of devices such as those disclosed herein.

In addition to a display 732, computer 700 may include one or more other peripheral output devices 734 including, but not limited to, an audio speaker, a printer, a storage device, and any combinations thereof. Such peripheral output devices may be connected to the bus 740 via an output interface 724. Examples of an output interface 724 include, but are not limited to, a serial port, a parallel connection, a USB port, a FIREWIRE port, a THUNDERBOLT port, and any combinations thereof.

The present disclosure encompasses execution or implementations of the method disclosed herein by any suitable combination of hardware and/or software, or both. Various illustrative logical blocks, modules, circuits, and algorithm steps described in connection with the embodiments disclosed herein may be implemented as electronic hardware, computer software, or combinations of both. For example, the various logical blocks, modules, described in connection with the embodiments disclosed herein may be implemented or performed at least in part by a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

The steps of a method described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Select televisions, video players, and digital music players with optional computer network connectivity are suitable for use in the system described herein. Suitable tablet computers, in various embodiments, include those with booklet, slate, and convertible configurations.

In some embodiments, the computing device includes an operating system configured to perform executable instructions. The operating system is, for example, software, including programs and data, which manages the device's hardware and provides services for execution of applications. Suitable server operating systems include, by way of non-limiting examples, FreeBSD®, OpenBSD®, NetBSD®, Linux®, Apple® Mac OS X Server®, Oracle Solaris®, Windows Server®, and Novell NetWare®. Suitable personal computer operating systems include, by way of non-limiting examples, Microsoft Windows®, Apple Mac® OS X, UNIX®, and UNIX-like operating systems such as GNU/Linux®. In some embodiments, the operating system is provided by cloud computing. Suitable mobile smartphone operating systems include, by way of non-limiting examples, Nokia Symbian® OS, Apple® iOS, Google® Android®, etc.

The functionality of the computer readable instructions may be combined or distributed as desired in various environments. In some embodiments, a computer program may include, in part or in whole, user interfaces such as dashboards that may be implemented using one or more web applications, one or more mobile applications, one or more standalone applications, one or more web browser plug-ins, extensions, add-ins, or add-ons, or combinations thereof.

In some embodiments, computer programs or software disclosed herein may use or interact with, by way of non-limiting examples, relational, non-relational, object oriented, associative, and XML database systems. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML).

While preferred embodiments of the present disclosure have been shown and described herein, such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions may occur without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that systems, methods and structures within the scope of these claims and their equivalents be covered thereby.

What is claimed is:

1. A processor-implemented method to detect cyber-threats related to an information technology (IT) system, the method comprising:
acquiring an event sequence comprising a plurality of network related events from the IT system, wherein the plurality of network related events occur over a time period;
obtaining, corresponding to the event sequence, a corresponding tokenized event sequence comprising a plurality of corresponding tokenized events, the plurality of corresponding tokenized events obtained by tokenizing the plurality of network related events;
embedding each corresponding tokenized event in the plurality of corresponding tokenized events with a corresponding positional embedding and a corresponding event embedding to obtain a corresponding positionally-embedded and event-embedded tokenized event sequence;
detecting, by a pre-trained log foundation model trained on network related logs, based on the corresponding positionally-embedded and event-embedded tokenized event sequence, one or more anomalies associated with the one or more network related events, wherein the anomalies are detected based on output embeddings in the pre-trained log foundation model; and
outputting anomaly information indicative of the one or more anomalies.

2. The method of claim 1, wherein the corresponding event embedding associated with each corresponding tokenized event is indicative of a position of an associated network related event in the event sequence.

3. The method of claim 1, wherein embedding each corresponding tokenized event in the plurality of corresponding tokenized events further comprises embedding the one or more corresponding tokenized events with a corresponding temporal embedding.

4. The method of claim 3, wherein the corresponding temporal embedding associated with each corresponding tokenized event is indicative of a time between events in the event sequence.

5. The method of claim 1, wherein anomalies are detected based on a comparison of the output embeddings by pre-trained log foundation model to the corresponding tokenized event sequence.

6. The method of claim 5, further comprising:
initiating an anomaly alert, when an anomaly score exceeds a threshold value, wherein the anomaly score is computed by:
determining, for each output token in the output embedding, a corresponding distance relative to the corresponding tokenized event in the corresponding tokenized event sequence; and
aggregating the corresponding absolute distance for each output token using an aggregation function.

7. The method of claim 1, further comprising:
classifying the anomalies into one or more classifications, wherein the classification is performed by one or more trained classification models based on the output embedding; and
generating an alert based, at least in part, on one or more corresponding confidence levels associated with the classification.

8. The method of claim 7, wherein at least one classification of the one or more classifications further comprises an anomaly score indicative of an anomaly level associated with the at least one classification.

9. The method of claim 7, wherein classifying the anomalies into one or more classifications further comprises determining one or more classifications in accordance with a standardized classification framework.

10. The method of claim 9, wherein the alert includes the one or more classifications, a confidence level associated with the classification, and a classification output embedding associated with the classification.

11. The method of claim 7, wherein the one or more trained classification models are obtained by fine tuning the pre-trained log foundation model.

12. The method of claim 7, wherein the one or more classifications comprise at least one of anomalies, attacks, or suspicious activity.

13. The method of claim 1, wherein tokenizing the one or more network related events is based on a custom vocabulary, wherein the custom vocabulary is derived from network log files used to train the log foundation model.

14. The method of claim 8, wherein output embeddings of a classifier are used in a continual learning mode, the method further comprising:
monitoring drift in the anomalies detected by the log foundation model, and
in response to a determination that the drift in the anomaly detection exceeds a threshold, initiating a continual learning pipeline to update artifacts and weights associated with the one or more classifiers via fine tuning.

15. A system to detect cyber-threats related to an information technology (IT) system, the system comprising:
at least one computer comprising a processor, a memory, and a network interface wherein the processor is configured to:
acquire, over the network interface, an event sequence comprising a plurality of network related events from the IT system, wherein the plurality of network related events occur over a time period;
obtain, corresponding to the event sequence, a corresponding tokenized event sequence comprising a plurality of corresponding tokenized events, the plurality of corresponding tokenized events obtained by tokenizing the plurality of network related events;
embed each corresponding tokenized event in the plurality of corresponding tokenized events with a corresponding positional embedding and a corresponding event embedding to obtain a corresponding positionally-embedded and event-embedded tokenized event sequence;
detect, by a pre-trained log foundation model trained on network related logs, based on the corresponding positionally-embedded and event-embedded tokenized event sequence, one or more anomalies associated with the one or more network related events, wherein the anomalies are detected based on output embeddings in the pre-trained log foundation model, the output embedding being stored in the memory; and
initiate output, to an entity in the IT system over the network interface, of anomaly information indicative of the one or more anomalies.

16. The system of claim 14, wherein the corresponding event embedding associated with each corresponding tokenized event is indicative of a position of an associated network related event in the event sequence.

17. The system of claim 14, wherein embedding each corresponding tokenized event in the plurality of corresponding tokenized events further comprises embedding the one or more corresponding tokenized events with a corresponding temporal embedding.

18. The system of claim 14, wherein the processor is further configured to:
classify the anomalies into one or more classifications, wherein the classification is performed by one or more trained classification models based on the output embedding; and
generate an alert based, at least in part, on one or more corresponding confidence levels associated with the classification.

19. A non-transitory computer readable medium comprising instructions to configure a processor to perform a method of detecting cyber-threats related to an information technology (IT) system, the method comprising:
acquiring an event sequence comprising a plurality of network related events from the IT system, wherein the plurality of network related events occur over a time period;
obtaining, corresponding to the event sequence, a corresponding tokenized event sequence comprising a plurality of corresponding tokenized events, the plurality of corresponding tokenized events obtained by tokenizing the plurality of network related events;
embedding each corresponding tokenized event in the plurality of corresponding tokenized events with a corresponding positional embedding and a corresponding event embedding to obtain a corresponding positionally-embedded and event-embedded tokenized event sequence;
detecting, by a pre-trained log foundation model trained on network related logs, based on the corresponding positionally-embedded and event-embedded tokenized event sequence, one or more anomalies associated with the one or more network related events, wherein the anomalies are detected based on output embeddings in the pre-trained log foundation model; and
outputting anomaly information indicative of the one or more anomalies.

20. The computer-readable medium of claim 18, wherein the corresponding event embedding associated with each corresponding tokenized event is indicative of a position of an associated network related event in the event sequence.
